(19) United States
(12) Patent Application Publication
(10) Pub. No.: US 2002/0133400 A1
(43) Pub. Date: Sep. 19, 2002

(54) Systems and methods for internet reward service

(75) Inventors: David C. Terry, Wayzata, MN (US); John R. Fox, Victoria, MN (US); Robert J. Beaudoin, Minneapolis, MN (US)

Correspondence Address: Schwegman, Lundberg, Woessner & Kluth, P.A., P.O. Box 2938, Minneapolis, MN, 55402, US

(73) Assignee: BOOMERANGMARKETING.COM INCORPORATED

(21) Appl. No.: 09/805,424

(22) Filed: Mar. 13, 2001

(51) Int. Cl. G06F 17/60

(52) U.S. Cl. 705/14

(57) ABSTRACT

Systems and methods are described which afford greater flexibility for consumers to purchase through either on-line or traditional retail venues and receive a more direct perceived value from reward offerings. The system's network of CPGs enables sponsors and partnered e-commerce retailers to share development, database management, and other administrative costs. Cooperative database mining combined with timely, anticipated and permission-based relevant e-mail communications adds a powerful customer acquisition component to traditional database and customer loyalty programs. Member users benefit from the flexibility in the ways in which they can accumulate value in their member user accounts from entering rewards received from CPG Sponsors. Member users also have flexibility in the manner in which they spend value accumulated in their consumer accounts. In the present invention, conducting online transactions with any one of the partnered e-commerce retailers is simplified and streamlined.

In particular, an illustrative embodiment of the present invention includes a system facilitating Internet reward services. The system includes a server coupled to the Internet. A website is stored on the server. Software means is operative on the website and the server. The software means receives one or more reward codes for verification against a network of consumer product/service sponsors and credits a proprietary value for valid reward codes to an appropriate member user's account such that a member user can apply the proprietary value to on-line transactions with a number of partnered e-commerce retailers. According to the teachings of the present invention, the software means is further operable for associating a reward activity process with a particular member user account and collecting data associated with an on-line transaction by the member user such that the collected data can be analyzed and shared between the network of consumer product/service sponsors and the number of partnered e-commerce retailers.

### RELATED CASES

This application is related to co-pending Application Serial No. 09/456,608, attorney docket number 1173.001 us1, filed on Dec. 8, 1999, entitled “Systems and Methods for Internet Rebate Service” by inventors David C. Terry, John R. Fox, and Robert J Beaudoin, which is hereby incorporated by reference.

### FIELD OF THE INVENTION

The present invention relates generally to the field of electronic commerce. More particularly, the present invention relates to systems and methods for an Internet reward service.

### BACKGROUND

The Internet has become a tremendous information and marketing resource tool. Even more, the Internet is a powerful agent which is transforming the way nearly every product and service is created and sold. With countless web sites proliferating at an extremely rapid rate the competition to develop consumer loyalty and hold the consumer's attention for repeat business is critical. It is recognized that the ease of product purchase and delivery to the consumer is not always enough. Today, the consumer is demanding an added quality of service and value.

Rebates on consumer products are a conventional method which product manufacturers have used to create purchase incentives and develop consumer loyalty by providing added value. Today, rebates on consumer products are booming, showing up on everything from large ticket appliances, electronics, computers and even baby seats. Rebate amounts are especially increasing for higher priced items. However, rebates can be viewed by consumers as a nuisance, and can generate a lot of ill will for companies that mishandle them. Consumers, including online consumers, want convenience and value built in with added incentives. With take anywhere from 10 to 12 weeks to receive the rebate. This leads to consumer frustration and a breakdown in the one-to-one relationship the product manufacturer seeks to establish with the consumer.

Further, the traditional rebate method involves extended involvement with point of sale retailers and the clearing houses which process the mail in rebates. Issues of processing time, cost, fraud elimination, and consumer perceived value all enter into the equation. If the retailer honors point of sale rebates, then the retailer must further re-claim the rebate amounts from the rebate offerer. In the instance of a mail in rebate, a consumer purchases a product, finds the order form and then must complete the form, including attaching cumbersome receipts and proofs of purchase in order to mail in the rebate for redemption. In this instance, a clearing house must then process the mail, including verifying the form, keying the rebate into a database to store the information, handling consumer call inquiries and/or complaints, and must print and mail out checks to the consumer for the rebate amounts. Again, in this lengthy process, the checks are often not received by the consumer for 10 to 12 weeks. After this period of time the consumer's perceived value and satisfaction has often diminished and any direct perceived relationship with the rebate offerer is lessened. What the consumer perceives is added frustration and no one-on-one interaction with the rebate offerer. Thus, no loyalty or repeat business is generated. Moreover, the rebate offerer has had no opportunity to cross promote to recover or reduce cost.

Two approaches to ameliorating this lengthy process are provided in U.S. Pat. No. 5,467,269 issued Nov. 14, 1995 to Flaten and U.S. Pat. No. 5,729,693 issued Mar. 17, 1998 to Holda-Fleck. Both of these patents describe systems and methods by which a consumer can enter rebate codes into an input device such as a telephone and, upon authorization of the rebate, receive a credit to their local phone bill. Consumers may perceive a more direct response from these systems and methods, but may accord the added value as coming from the phone company versus the rebate offerer. Also, other consumers may still desire rebate compensation in alternative formats, e.g. direct cash credit for immediate use in other purchases.

As stated at the start, consumers are now conducting online transactions via the Internet at an ever increasing rate. This is due to the fact that a multitude of Internet commerce offerers, e.g. companies offering online sales of products and merchandise, have made it easy for the consumer to conduct an entire purchase transaction from a remote client such as a home computer. For these reasons, many online commerce offerers are providing immediate discounts or point incentives for transactions conducted over the Internet. For example, certain Internet commerce offerers will provide the online user with the opportunity to accumulate frequent flyer miles or points toward future purchases when conducting a transaction online through their service. Alternatively, the online commerce offerer may mail check rebates or coupons to the consumer once the requisite number of points are accumulated. Unfortunately, such mechanisms conventionally involve only single brand loyalty. They do not offer the consumer the opportunity to accumulate value across multiple brands and pool those values to spend in the consumer's desired manner. This set-up still affords only delayed gratification to the user and a decrease in perceived value.

Other Internet commerce offerers provide a discount off the retail price immediately at the time of online purchase. Still the online user has to purchase the good from the retailer which offers such online transaction and wait for the product to be shipped and arrive at some later date. For this reason many consumables such as large appliances, electronics, and groceries, just to mention a few examples, are still purchased at brick and mortar facilities where the consumer can immediately take home the product. In these cases, the consumer is forced to rely on conventional, delayed techniques for obtaining rebates and suffers from the restrictiveness of not being able to accumulate value across multiple brands. Systems and methods are further desirable through which consumer goods and service providers can more effectively market to their best consumers and improve consumer loyalty and margins.

Conventional efforts to target and market to a company's best consumers require specific businesses to bear the entire cost of developing and manufacturing databases to track spending and communicate with their current customers.

For the reasons stated above, and for other reasons stated below which will become apparent to those skilled in the art upon reading and understanding the present specification, it is desirable to develop systems and methods which afford greater flexibility for consumers to purchase through traditional retail venues and/or online venues and still receive an additional direct value for a qualifying purchase of a specific good(s) or service(s).

### SUMMARY OF THE INVENTION

The above mentioned problems associated with consumer goods and service reward methods and systems as well as other problems are addressed by the present invention and will be understood by reading and studying the following specification. Systems and methods are described which afford greater flexibility for consumers to purchase through either on-line or traditional retail venues and receive a more direct perceived value from reward offerings. The system's network of consumer goods and service providers enables sponsors to share development, database management, and other administrative costs. In addition sponsors and partnered e-commerce retailers can work together to learn about the shopping habits of their customers and non-customers (member users) and to develop innovative, highly targeted marketing strategies to acquire new customers and increase the loyalty and profitability of current ones. Cooperative database mining combined with timely, anticipated and permission-based relevant e-mail communications adds a powerful customer acquisition component to traditional database and customer loyalty programs.

Member users benefit from the flexibility in the ways in which they can accumulate value in their member user accounts from entering reward codes received from consumer product manufacturers and service providers in the network of sponsoring companies. For example, members can earn value from purchases made at bricks and mortar retail locations, online purchase transactions, and through bonus sweepstakes or game overlays. According to the teachings of the present invention, Members also have flexibility in the manner in which they spend reward value accumulated in their consumer accounts. In the present invention, conducting online transactions to spend rewards with any one of the partnered e-commerce retailers is simplified and streamlined, using an innovative, automated check-out method.

In particular, an illustrative embodiment of the present invention includes a system facilitating Internet reward services. The system includes a server coupled to the Internet. A website is stored on the server. Software means is operative on the website and the server. The software means receives one or more reward codes for verification against a network of consumer goods and service sponsors and credits a proprietary value for valid reward codes to an appropriate member user's account such that a member user can apply the proprietary value to on-line transactions with a number of partnered e-commerce retailers.

According to the teachings of the present invention, the software means is further operable for associating a reward activity process with a particular member user account and collecting data associated with an on-line transaction by the member user such that the collected data can be analyzed and shared between the network of consumer goods and service sponsors and the number of partnered e-commerce retailers.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIG. 1A is an illustration of a system level embodiment according to the teachings of the present invention.

FIG. 1B is a block diagram for one embodiment of a networked infrastructure according to the teachings of the present invention.

FIG. 2 is a diagram of a hardware and operating environment in conjunction with which embodiments of the invention may be practiced.

FIG. 3 is an illustration of another system level embodiment according to the teachings of the present invention.

FIG. 4 is a flow chart illustrating one method embodiment according to the teachings of the present invention.

FIG. 5 is a flow chart illustrating another method embodiment according to the teachings of the present invention.

FIG. 6 is a flow chart illustrating an embodiment for a active server page sequence according to the teachings of the present invention.

FIGS. 7-11 illustrate screen shots embodiments for active server pages according to the teachings of the present invention.

### DETAILED DESCRIPTION

In the following detailed description, reference is made to the accompanying drawings which form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

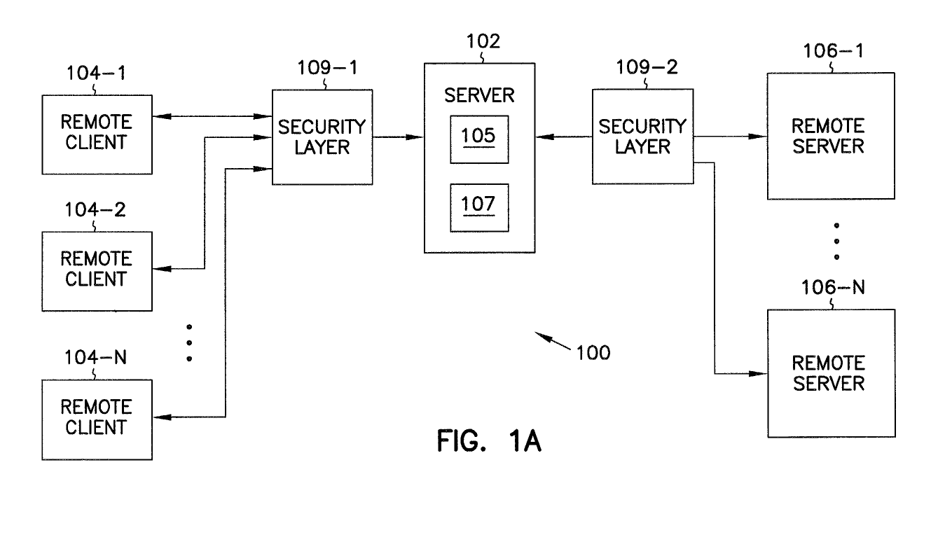

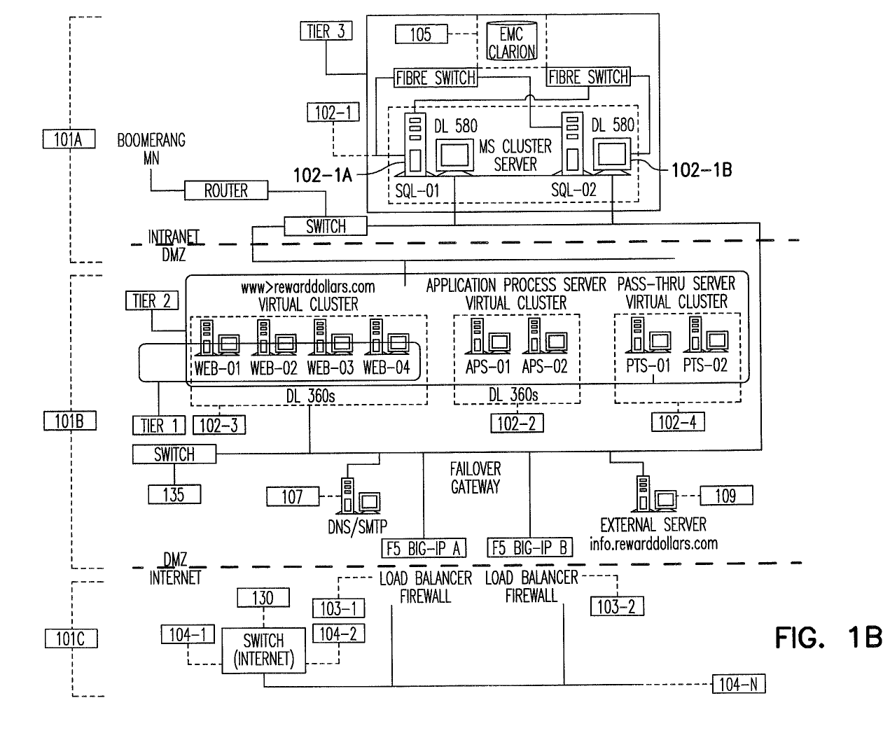

FIG. 1A is an illustration of a system 100 according to the teachings of the present invention. The system 100 can include an Internet network system 100. In FIG. 1A, the system 100 includes a server 102. Server 102 includes a processor 105 coupled to a data storage device 107. The system 100 further includes a number of remote clients 104-1, 104-2, . . . , 104-N each including a client program, or software means, which is operatively or communicatively coupled to the server 102. In one embodiment, the number of remote clients 104-1, 104-2, . . . , 104-N are operatively coupled to the server 102 through a first security layer 109-1, or secure data network 109-1 such as the architecture available from Level 3 Communications. In another embodiment, the number of remote clients 104-1; 104-2 , . . . , 104-N each including a client program, or software means, include software which provide security at the number of remote clients 104-1, 104-2, . . . , 104-N. In one embodiment, one or any number of remote clients 104-1, 104-2, . . . , 104-N are coupled to the server 102 over a local area network (LAN), e.g. an Ethernet network. In an alternative embodiment, one or any number of remote clients 104-1, 104-2, . . . , 104-N are coupled to the server 102 over a wide area network (WAN). Also, one or any number of remote clients 104-1, 104-2, . . . , 104-N can be coupled to the server 102 over the public switched telephone network (PSTN) and/or the Internet. In one embodiment, by way of example and not by way of limitation, the number of remote clients 104-1, 104-2, . . . , 104-N can communicate with one another and the server 102 using transmission control protocol/internet protocol (TCP/IP).

The system 100 can include coupling, as described above to additional servers and systems 106-1, . . . , 106-N, e.g. servers maintained by other commercial online e-commerce retailers. Such systems are known and understood by one of ordinary skill in the art. In one embodiment, the additional servers and systems 106-1, . . . , 106-N include core databases accessible by the server 102. For example, the additional servers and systems 106-1, . . . , 106-N include databases and executable instructions for maintaining consumer accounts and purchase records, conducting financial transactions such as credits and debits to a number of consumer accounts, and producing reporting records.

As one of ordinary skill in the art will understand upon reading this disclosure, the core databases accessible by the server 102 will facilitate cooperative database mining for a network of consumer goods manufacturers and service providers such that the sponsors can track consumer purchase records and provide rewards as well as identify marketing and promotional opportunities. In other words, the system and methods of the present invention will allow sponsors to identify their best consumers in order to increase profits and cost-effectively grow the base of loyal consumers.

In one embodiment, the additional servers and systems 106-1, . . . , 106-N include proprietary databases and data modules. In one embodiment, the additional servers and systems 106-1, . . . , 106-N are similarly coupled to the server 102 through a second security layer 109-2, or secure data network 109-2 such as offered by Level 3 Communications. In one embodiment, the additional servers and systems 106-1, . . . , 106-N are coupled to the server 102 over a local area network (LAN), e.g. an Ethernet network. In an alternative embodiment, the additional servers and systems 106-1, . . . , 106-N are coupled to the server 102 over a wide area network (WAN). Also the additional servers and systems 106-1, . . . , 106-N can be coupled to the server 102 over the public switched telephone network (PSTN) and/or the Internet.

According to the teachings of the present invention the proprietary databases and data modules contain information on consumers from all of the participating sponsor companies in the network. The database structure, therefore, creates the opportunity for interactive communications and the ability to model and target high-potential value customers/consumers based on demographic and brand preference data. Unlike traditional customer loyalty and database marketing programs —where specific businesses bear the entire cost of developing and maintaining databases to track spending and communicate with their current customers— the system's network of sponsors enables them to share development, database management, and other administrative costs. In addition sponsors can work together to learn about the shopping habits of their customers and non-customers and to develop innovative, highly targeted marketing strategies to acquire new customers and increase the loyalty and profitability of current ones. Cooperative database mining combined with timely, anticipated and permission-based relevant e-mail communications adds a powerful customer acquisition component to traditional database and customer loyalty programs.

As one of ordinary skill in the art will understand upon reading this disclosure, the system architecture of the present invention combines the best of direct marketing with the economies of scale only attainable through large, shared, mass promotional programs. In effect, the system architecture enables companies to benefit from the advantages of traditional customer loyalty, direct marketing and sales promotion programs while overcoming many of the hurdles associated with them.

The server 102 can be coupled to the remote client 104 and the additional servers and systems 106-1, . . . , 106-N in a direct hardwired fashion, e.g. hybrid fiber-coax connection and/or indirectly in a wireless fashion using remote electromagnetic signal transmission in the radio or microwave frequencies. In FIG. 1, the server 102, the remote client 104, and the additional servers and systems 106-1, . . . , 106-N all include computer readable medium having computer-executable instructions. These computer readable medium include such devices as a disk drive for reading data storage media, e.g. a compact disc and/or computer readable medium such as random access memory (RAM) and read only memory (ROM). Similarly, the server 102, the remote client 104, and the additional servers and systems 106-1, . . . , 106-N can all include processor capabilities coupled to a data storage device.

FIG. 1B is a more detailed block diagram for one embodiment of a networked infrastructure for the system's architecture 100 in FIG. 1A according to the teachings of the present invention. The networked infrastructure for system 100 can comprise a local area network (LAN), e.g. an Ethernet network. In an alternative embodiment, the networked infrastructure for system 100 can comprise a wide area network (WAN). Also, the networked infrastructure for system 100 can comprise a public switched telephone network (PSTN) and/or an Internet network. As shown in FIG. 1B, one embodiment of the networked infrastructure for system 100 includes a number of server clusters 102-1, 102-2, 102-3, 102-4, etc having designated roles. Within a given server cluster, e.g. cluster 102-2 and 102-3, a number of redundant servers or duplicate web and application servers are included, to avoid a single point failure. In the case of redundant web (i.e. portal) servers, requests will be divided up by using a number of load balancers, e.g. 103-1 and 103-2 such as a load balancer product like F5's Big IP load balancer/firewall. In one exemplary embodiment, DCM/COM will be used as the communication mechanism between sub-systems of system 100. As one of ordinary skill in the art will understand upon reading this disclosure, other communication protocols, such as HTTP/HTTP and SQL server database communication (T.S.—tabular data stream), are similarly included within the scope of the present invention. According to the teachings of the present invention, COM components can be used directly by active server pages (asps). In one exemplary embodiment, the architecture of system 100 will take advantage of Microsoft Transaction Server (ITS) and ADO for database connection and pooling. This architecture will be taking advantage of the thread pooling that is provided by Microsoft Internet Information Server (i.e. IIS).

A high level overview of FIG. 1B is explained as follows. The top portion of the diagram 101A displays an embodiment for a proprietary intranet network as part of the system's architecture. The proprietary intranet network includes proprietary database servers shown as server cluster 102-1A and 102-1B and related disk storage 105. The key here is that these devices are not directly accessible from the Internet. This is illustrated in FIG. 1B by the hash mark separation line indicating a DMZ (demilitarized Zone). As one of ordinary skill in the art will understand upon reading this disclosure, the DMZ serves as a barrier between the Internet and a company's intranet. It is a subnet that contains a firewall and proxy server, which can be in separate servers or in one server. The firewall connects to an external firewall on the Internet side, which may be at the ISP's location and is often called a “boundary router.” A double firewall architecture can be included to add an extra measure of security for the intranet. Shown in the embodiment of FIG. 1B server cluster 102-1 is a MS cluster server 102-1 having a SQL server 1 and SQL server 2. In one embodiment, these servers work as a pair, with only one being active at a time. One server acts as the primary server and the other server is in waiting in case the primary server should not respond to requests.

The middle portion 101B of the diagram shows another cluster of servers 102-3 which serve as the Web Servers 102-3. These Web Servers 102-3 are labeled in the embodiment of FIG. 1B as WEB-1, WEB-2, WEB-3, . . . , WEB-N. These Web Servers 102-2 run two levels, or tiers, of a multi-tier solution according to the teachings of the present invention. On the one side, these Web Servers 102-3 process web page requests for remote client/member users, 104-1, 104-2, . . . , 104-N, using a number of active server pages. On the backside, these Web Servers 102-3 process all the rules and data requests to and from the proprietary database servers 102-1A and 102-1B shown as part of the proprietary intranet network at the top of FIG. 1B.

Also shown in the middle portion 101B of the diagram is a cluster of servers labeled as Application Process Servers 102-2. The Application Process Servers 102-2 are a part of Tier 2 in the present invention. According to the teachings of the present invention, these Application Process Servers 102-2 process all requests for payment related services within the system of the present invention. This includes new account creation, balance inquiries, and account status. Application Process Servers 102-2 utilize a secure SSL connection to a Stored Value Provider's network in order to provide the services and implement the methods of the present invention.

Further shown in the middle portion 101B of the diagram is a cluster of servers labeled as Pass Thru-Servers 102-4. The Pass Thru-Servers 102-4 are also a part of Tier 2 in the present invention. The Pass Thru-Servers 102-4 act as the go between for the system's shoppers and the partnered e-tailed web sites as explained in more detail below. The Pass Thru-Servers 102-4 intercept web pages from the partnered e-tailed and either forward them unchanged to the member's web browser or they actually respond to these web pages on the member's behalf. According to the teachings of the present invention, if the member is at a certain stage of the checkout process with the partnered e-tailed, the Pass Thru-Servers 102-4 will fill out the appropriated system billing and account information in order to facilitate payment with a member's reward values from their account instead of their personal commercial credit card account.

The bottom portion 101C of the diagram displays the Load Balancing Farewells 103, which provide a central point of security and access for all Internet traffic. Here too is illustrated, in the embodiment of FIG. 1B, a hash mark separation line indicating a DMZ separation. In the embodiment shown in FIG. 1B, two load balancing firewall units 103-1 and 103-2 are shown. According to the embodiment, these units can also work as a pair, with only one being active at a time. The other unit acts as a hot spare.

As one of ordinary skill in the art will understand upon reading this disclosure, the embodiments provided in FIG. 1B are provided by way of illustration and not by way of limitation. One of ordinary skill in the art will further understand the manner in which additional hardware can be added to the network embodiment shown in FIG. 1B without departing from the thrust and scope of the system's architecture. As one of ordinary skill in the art will understand upon reading this disclosure, the application embodiment shown in FIG. 1B can be referred to as an n tier Microsoft centric application.

In the embodiment shown in FIG. 1B, three tiers are defined according to the teachings of the present invention. These are labeled Tier-1, Tier-2, and Tier-3. According to the teachings of the present invention, two of the three tiers, Tier-l, and Tier-2 are run on the Web Servers. In the embodiment shown in FIG. 1B, the two tiers which are run on the Web Servers include the client interface shown as Tier-1 and a “Middle Tier,” shown as Tier-2. Tier-1 includes HTML/Active Server Pages (ASPS). In the embodiment shown in FIG. 1B, the middle tier, Tier-2, can be referred to as the COM layer (Tier-2), as it uses Microsoft's Component Object Model. The Tier-2 layer basically consists of dlls that are called by ASP to do most of the system processing. Tier-2 includes a link to Tier-3. In the embodiment shown in FIG. 1B, Tier-3 includes a Microsoft SQL Server database using ADO technology. According to the teachings of the present invention, the COM layer, Tier-2, serves as the go-between, or intermediary, from a remote client/member Internet user, 104-1, 104-2, . . . , 104-N, and the server database maintained in Tier3.

According to the teachings of the present invention, the bulk of application processing occurs in the Web Server tiers, Tiers 1 and 2 respectively. Thus, as one of ordinary skill in the art will understand upon reading this disclosure, the system architecture can be scaled up by adding additional web servers. This is easily done by adding web servers to the BIG/IP virtual cluster, Tiers 1 and 2 respectively: In the embodiment of FIG. 1B, two BIG/iP virtual clusters are shown as BIG/iP A and BIG/iP B. For even greater efficiency, the BIG/iP box off-loads many of the requests normally handled by the Web Server, such as SSL processing.

The third tier, Tier-3, of the system's architecture includes the backend server database. According to one embodiment of the present invention, shown in FIG. 1B, the backend server database in Tier-3 includes a Microsoft SQL Server 2000 database. According to the teachings of the present invention, the backend server database primarily runs stored procedures, requested by the COM layer (Tier2), to access an appropriate consumer/remote client/member account and/or other data required as the same will be understood upon reading this disclosure. Stored procedures provide excellent performance and hide the database implementation details from the other application tiers, which provides for additional application security as well as application robustness.

As one of ordinary skill in the art will understand upon reading this disclosure, the system architecture of the present invention revolves around four key fundamental attributes: Reliability, Scalability, Flexibility, and Security. Each of these attributes is further expounded upon as explained in more detail below.

The system architecture of the present invention is designed to be available for remote client/member's use at all times. This is critical for providing a quality experience for the number of remote client/member users and the network of consumer goods manufacturers and service provider sponsors. One of the techniques used to ensure that the system is always available is referred to as a “Rolling Upgrade”. This allows the capability to bring a portion of the system down, make the necessary changes or enhancements, and then bring that portion back online while the other parts of the system remain filly operational. In one embodiment, these Rolling Upgrades are implemented during off-peak times to ensure satisfactory performance during times of upgrades.

Another technique employed to enable continuous uptime is full redundancy. Every component of the system's architecture 100 is mirrored, that is, there are two of everything. In the embodiment shown in FIG. 1B, there are actually four Web Servers shown in cluster 102-3, two each on separate power distribution units (PDUs), and two Load Balancing Farewells 103-1 and 103-2, again each one on a different PDU. In the embodiment shown in FIG. 1B, the system architecture utilizes two large-scale Database Servers, SQL-1 and SQL-2 shown in cluster 102-1, each one on a separate PDU. In the embodiment shown in FIG. 1B, these two Database Servers, SQL-1 and SQL-2, are unique in that only one runs at any particular time. The other serves as a Hot Spare, also known as a Stand By Unit. The benefit gained with this technique is simplicity and reduced risk of errors while attempting to run two Database Servers, SQL-1 and SQL-2, simultaneously.

In one embodiment, the Database Servers, SQL-1 and SQL-2, run Windows 2000 Advanced Server with Microsoft's Cluster Server in an Active-Passive mode. This means that only one box is actually processing transactions at a time. According to the embodiment shown in FIG. 1B, it takes approximately 25 seconds to cut over to the passive box should the active box fail. An example of the Database Servers, SQL-1 and SQL-2, can include but is not limited to, SQL 2000, Service Pack 1 as the same is known and understood by one of ordinary skill in the art. This takes full advantage multiprocessor high end servers.

In one embodiment, the data storage used in the system architecture uses dual-loop fibre channel connections to a RAID 1+0 EMC storage array with dual power supplies, each fed from a separate PDU. One of ordinary skill in the art will understand the same upon reading this disclosure. However, the above descriptions are intended to be illustrative of the currently existing hardware devices which can be employed to construct the system architecture of the present invention. One of ordinary skill in the art will appreciate that the invention is not limited to the particular hardware devices described herein and that future hardware improvements which achieve the functions described herein are included in the scope of the present invention.

In one embodiment, the system architecture of the present invention assures reliability by networking with a co-location partner. One such co-location partner, as the same will be known and understood by one of ordinary skill in the art, includes Exodus Corporation. In one embodiment, all of the equipment for the system architecture is physically located at a facility owned and operated by Exodus. In this embodiment, the services that Exodus provides are referred to as Hosting, or Site Hosting services, as the same is known and understood by one of ordinary skill in the art. In this embodiment, the Site Hosting services basically provide the system architecture with electrical power and Internet connectivity. As one of ordinary skill in the art will appreciate, such a co-location partner will provide the systems and methods of the present invention with multiple sources of electrical power, nearly unlimited access to the Internet, and a highly secure physical environment.

In one embodiment, such multiple sources of electrical power can include power which is backed up with several hours of online battery backup and three diesel generators that are run every week for testing purposes. Such multiple sources of electrical power can further include power run from separate power grids within a city power grid.

According to the teachings of the present invention, the BIG/iP load balancers referred to above have multiple verification features that allow proprietary access to the system architecture in the same manner in which a remote client/member user would access the same. According to the teachings of the present invention, using such proprietary access provides the capability to automatically remove a web server from the any of the above described clusters when one is not responding properly. According to the teachings of the present invention, the system architecture and application is not dependent upon state management in the above described Tier-2 (which runs on the web server). Thus, as will be explained in more detail below, different pages from a same remote client/member user session may actually be served and processed by any available web server in the above described clusters.

According to the teachings of the present invention, the system architecture and methods provide for scalability. That is, the present invention's platform is able to rapidly adjust to higher transaction volumes. The system architecture and methods provide a real-time system. According to the teachings of the present invention, all deposit transactions, which are described in more detail below, must be completed quickly. The system architecture and methods provide for the same while a remote client/member is using the present invention.

According to the teachings of the present invention, the system architecture can be scaled up in several ways. The first option is to add more servers and/or increase the capacity of individual servers. Again this can be done using the Rolling Upgrade process as described earlier, for both Web Servers (Tier-1, Tier-2) and Database Servers (Tier-3).

The system architecture and methods further provide the option of increasing the speed of an Internet connection. That is, the system is configured to burst the bandwidth to 100 Mbps in real-time. One of ordinary skill in the art will know and understand the same upon reading this disclosure in connection with the above described Hosting partner's capabilities. In this manner, the system's architecture and methods facilitate handling more simultaneous remote client/member user sessions, while still providing good performance.

The basic approach for providing system scalability is inherent in the system architecture. The system architecture provides for “spread out” system transactions across several computers. The software tools selected as part of the system's architecture allow the system to actually take advantage of more than one processor (CPU) in a Database Server, for example.

According to the teachings of the present invention the F5 BIG-IP load balancers, described above, take care of routing traffic to the least busiest web server and also off-load SSL processing from the web servers. In addition they have several security features such as IP filtering.

According to the teachings of the present invention, the system architecture and methods include several types of security measures. The first of which is in the form of Proof-Of-Purchase Codes (POPs). In the present invention, the proof-of-purchase code, also referred to as a reward code, has many built-in security measures. These include a multi-part creation algorithm, a unique and secure method of storage, a secure printing process, and several other actions. The security measures described herein relating to the reward codes represent one of the core technical competencies built into the system's architecture and operable by the software means of the present invention.

A second form of security measure for the present invention relates to transaction deposits. According to the teachings of the present invention, deposits can not be made directly in the system's architecture. In the invention, a remote client/member user must first be authenticated via a log-in process operably with the software means. Once logged in to the system, the software means placing limits on the number of invalid deposits an individual remote client/member user may attempt. In the invention, direct access to a proprietary deposit web page is controlled via URL encryption of several concatenated fields.

According to the teachings of the present invention, software means operable on the system's architecture tracks a behind-the-scenes Fraud Score for each deposit (e.g. reward code entered into a consumer account as explained in more detail below) by a remote client/member user. According to the teachings of the present invention, this scoring algorithm looks at various aspects of the deposit in order to determine if the remote client/member user is trying to guess at reward codes or for other code entry irregularities.

Another important aspect of the system's architecture involves a consumer account creation. According to the teachings of the present invention, it is important, for a number of reasons, to make sure that the system can validate a remote client/member user's identity. The system's architecture accomplishes this using various methods including address validation and other behind-the-scenes fraud scoring techniques as mentioned above in connection with the software means.

The software means of the present invention performs a number of functions including address scrubbing, domain checking, and other related techniques for real-time account validation. One of ordinary skill in the art will understand upon reading this disclosure, the various programming languages in which the software means can be written to perform the functions mentioned above. The invention is not so limited.

Thus, one of ordinary skill in the art will understand upon reading this disclosure, that the system architecture of the present invention is designed so that proprietary core data is not directly accessible via the Internet. It has also been shown that the system's architecture includes multiple points and levels of security, including firewalling and encryption as the same will be understood by one of ordinary skill in the art upon reading this disclosure.

As mentioned above, there are a number of security measures included with the present invention's architecture and software means. Several of the other security protections built into the system include software means for monitoring the number of invalid log-in attempts and dealing with lost or forgotten passwords. One of ordinary skill in the art will understand upon reading this disclosure, the various programming languages in which the software means can be written to accomplish the above described software functions and design methodologies.

Another set of security measures for the present invention includes an outside monitoring of the system that takes place from a proprietary location which has access to the system's architecture as mentioned above. As such, various log-in and error files for certain suspicious activities by a remote client/member user can be checked.

Another advantage of the present invention includes the flexibility which the system's architecture provides to both the network of consumer product manufacturers and service providers (“Sponsors”) and the remote client/member user (“Members”). For example, according to the teachings of the present invention, Sponsors have the ability to add bonus rule options to particular consumer products/services to restrict code deposits if necessary, and to assign different value levels to different SKUs, as the same are known and understood by one of ordinary skill in the art, within a brand family.

Using the software means operating on the system's architecture, sponsors also have access to graphical reports, which summarize activity by SKU or service, as well as other reports that can aggregate activity across a brand family.

On the remote client/member user side, the software means operating on the system's architecture provides the following flexibility. In the present invention, Members have flexibility in the ways in which they can earn a value in their consumer accounts from entering reward codes received from sponsor companies. For example, members can earn value from purchases made at bricks and mortar retail locations, online purchase transactions, and through bonus sweepstakes or game overlays. According to the teachings of the present invention, Members also have flexibility in the manner in which they spend value accumulated in their consumer accounts. In the present invention, conducting online transactions is simplified and streamlined. In the invention, the system's architecture and software means facilitate an easier “checkout” from an online transaction than is currently possible using existing online checkout procedures. According to the teachings of the present invention, the architecture includes a number of e-commerce retailers (e-tailers) who are associated or partnered in the system. As mentioned above, these partnered e-tailers are linked into the number of active server pages such that a remote client/member user can shop through the websites of those e-tailers from within the system. The check out pages, served by partnered e-tailers are identified and filled-in automatically by the software means using data retrieved from a Member's consumer account.

According to the teachings of the present invention, a shopping checkout form, auto-fill technology is employed by the software means which provides a robust, real-time analysis of a remote client/member user's (Member's) online shopping experience. Thus, the software means operable on the system's architecture provides a remote client/member user (Member) with a more flexible and pleasant online shopping experience than currently exist for conducting online transactions. One of ordinary skill in the art will understand upon reading this disclosure the various programming languages in which the software means can be written to facilitate the inventive functions described above. The invention is not so limited to a particular programming language.

According to the teachings of the present invention, much of the flexibility in the system's architecture comes from the data-driven design and the black box design methodology of the inventive system. It is appreciated that one of ordinary skill in the art will appreciated the same upon reading the present disclosure. One of ordinary skill in the art will further appreciated that data-driven options in other prior art technologies only make sense to a certain point. That is, the data-driven options in many prior art technologies often reach a point when performance, especially disk I/O, suffers. According to the teachings of the present invention the system's architecture utilizes data-driven techniques primarily for deposit rules in order to avoid such prior art pitfalls.

In the present invention, the black box design allows for portions of the system's architecture to be changed when necessary for either functional or performance reasons, without impacting all of the other major components of the system. As such, the present invention provides a key advantage over prior art systems in its ability to adapt to new environments and Sponsor or Member requests.

As shown in FIG. 1B, the networked infrastructure for system 100 includes a number of remote clients 104-1, 104-2, . . . , 104-N coupled to the networked infrastructure for system 100.

As shown in FIG. 1B, server clusters 102-1, 102-2, 102-N, etc. include an number of servers which will each have resident processors and data storage devices upon which software programs can be executed and stored. The servers in the clusters can be used to generate or facilitate the creation of POP codes for any particular reward program. The servers in the clusters can store the generated POP numbers in PIN databases in the server clusters. These POP numbers can further be provided to the particular Sponsor, for whom a particular reward program was created, so that the Sponsor can include the POPs with the sale of its consumer products or services, either through an electronic point-of-sale (POS) system or on/in the package itself. In one exemplary embodiment, management of the POP, or PIN databases, will be performed by COM objects and classes which will provide all the functionality to satisfy the business and functional requirements of the reward system. The servers in the clusters can be used to generate or facilitate the creation of POP numbers for a reward program based on inputs which include, but are not limited to, an item id, a program id, a lot size, and a statistical distribution range. A software program is used which can be executed on the various servers and the reward analysis module to manage the life cycle of PINS in the reward system. One of ordinary skill in the art will understand upon reading this disclosure, that this software program can be created using any number of programming languages and paradigms, e.g. C++, COM, and/or Java. This software program is operable on the server clusters to create a set of PINS for a given reward program. These PINS can be validated in the course of a consumer reward deposit using the analysis module and PIN databases in the server clusters. The software program will further disable a PIN once a consumer reward process has been completed successfully. The software analysis module can retrieve the set of valid POP numbers for a given reward program from the server clusters. At least one server, e.g. a report server, in the server clusters can be used for generating a number of reward reports which can be provided to and/or made accessible online to a Sponsor. In one embodiment, the number of reward reports can be generated by the report server using the COM objects and classes executable in the server clusters.

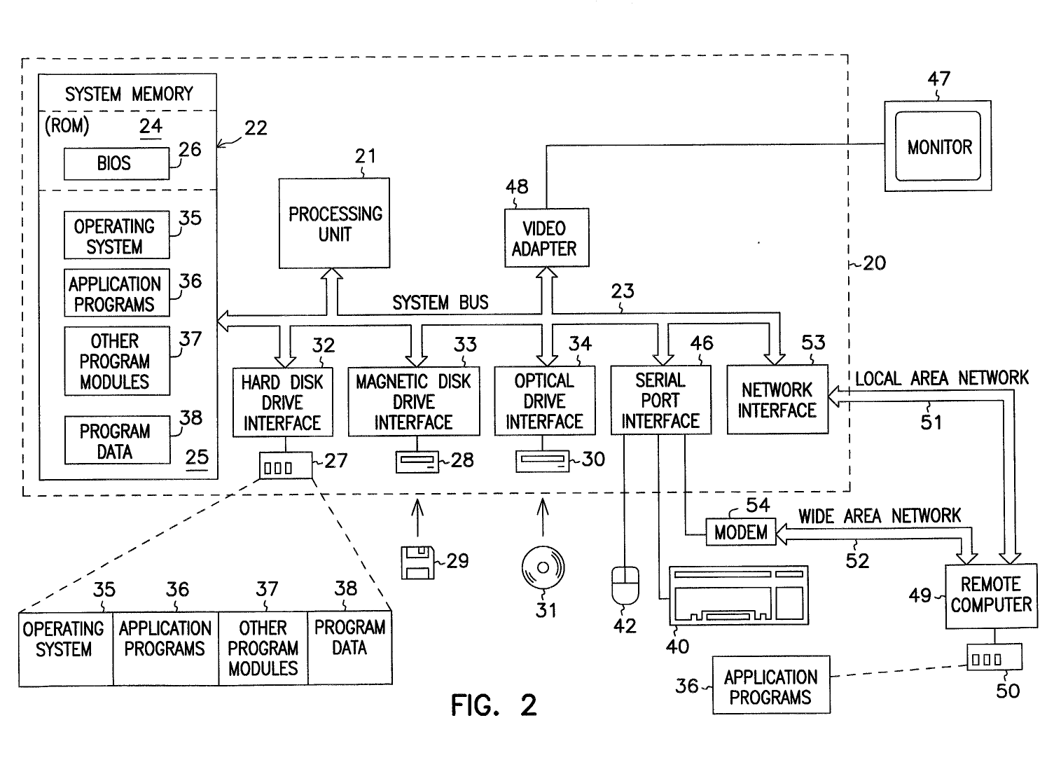

As stated above, the number of remote clients 104-1, 104-2, . . . , 104-N in FIG. 1B can comprise of a number of remote clients 104-1, 104-2, . . . , 104-N of different types. For example, in FIG. 1B the remote clients 104-1, 104-2, . . . 104-N include remote clients which are coupled online to the Internet. In this embodiment, the remote clients 104-1, 104-2, . . . 104-N include a computer having a graphical user interface and operable for running or executing a client program. An input device, e.g. a keyboard, is coupled to each remote client 104-1, 104-2, . . . 104-N as described more in connection with FIG. 2. In operation, a user at remote client 104-1, 104-2, . . . 104-N, couples to the networked infrastructure for system 100 by inputting a universal resource locator (URL) address into the remote client using the input device. As one of ordinary skill in the art will understand upon reading this disclosure, the client program at the remote client 104-1, 104-2, . . . 104-N can include a browser program which takes the URL address uses Internet Protocol (IP), e.g. HTTP/HTTP, and couples through an Internet hub 130 to establish a connection with the networked infrastructure for system 100. In one embodiment, the remote clients 104-1, 104-2, . . . 104-N, connect with the networked infrastructure for system 100 through a series of farewells, shown generally in FIG. 1B as 103-1 and 103-2. As one of ordinary skill in the art will understand upon reading this disclosure, any number of commercially available Internet Service Providers (ISP) can be used by the remote clients 104-1, 104-2, . . . 104-N to connect with the Internet. As shown in FIG. 1B, the remote clients 104-1, 104-2, . . . 104-N, are coupled to the server web cluster through a number of load balancers 103-1 and 103-2. The number of remote clients 104-1, 104-2, . . . 104-N, can further couple with an internal hub 135 using structured query language (SQL) for the networked infrastructure for system 100. In operation, the number of remote clients 104-1, 104-2, . . . 104-N, can transfer data to the networked infrastructure for system 100 according to the rules described above. In one embodiment, this data is exchanged or transferred back and forth between the number of remote clients 104-1, 104-2, . . . 104-N, and the networked infrastructure for system 100 in the form of a number of active server pages which are downloadable and displayable to a remote client. The number of active server pages are then used to perform the methods described in the present invention. For example, a user at remote client 104-1, 104-2, . . . 104-N, addresses a proprietary web site using a specific URL address and Internet Protocol. In one embodiment of the present invention, the proprietary website is maintained or stored on the servers in the server clusters. The invention, however, is not so limited to a particular server, and other partnered or hosting servers may be used, as described above without departing from the scope of the present invention. The servers in the server clusters can then download a number of active server pages to a client program at the remote client 104-1, 1042, . . . 104-N, which are displayable on a graphical user interface attached to the remote client 104-3 or 104-N. The number of active server pages are used to capture or collect data which can be input online to the active server pages using the input device at the remote clients 104-1, 104-2, . . . 104-N.

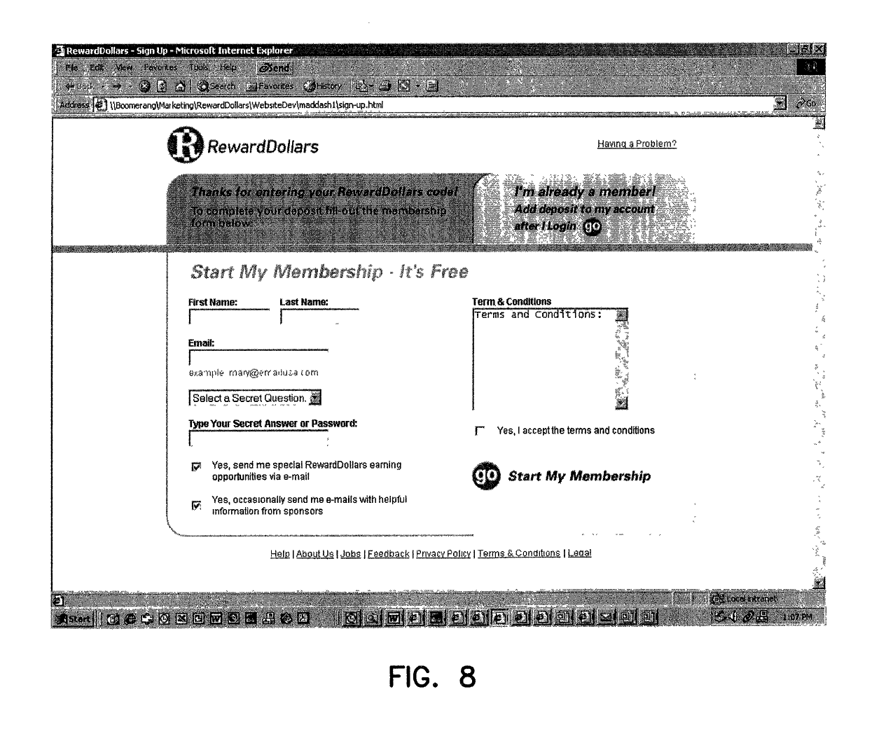

As shown in FIG. 1B, the server clusters include an number of servers which will each have resident processors and data storage devices upon which software programs can be executed and stored. As described above, according to the teachings of the present invention, the software means operable on the networked infrastructure, or system's architecture is adapted for creating a reward program for one or more consumer products or services company serving as a sponsor in the network. In the invention, these reward programs can then be executed on the servers in the server clusters. As one of ordinary skill in the art will understand upon reading this disclosure, such reward programs can be created using any number of programming languages and paradigms, e.g. C++, COM, and/or Java. Again, depending on the objectives and needs of a particular consumer goods or service provider for whom the reward program is created, this can be as easy as two options with data collection, or as complex as several hundred possible unique paths. Some representative active screen menus are provided, by way of example, in FIGS. 8-12, as discussed in more detail below. The reward program is then operable over the networked infrastructure 100. The reward program defines the types of rewards possible, will perform reward code processing, e.g. authentication and verification, with the use of an analysis module, and manage a remote client/member user's experience with a reward offer over the life cycle of the reward program. In other words, a reward program will interact with a reward code analysis module as executed on the server clusters to define the business rules of the reward offer, e.g. perform fraud analyses, check dates and proof of purchase codes (POP). The software analysis module can retrieve the set of valid POP codes for a given program from server cluster 102-1, as described above. The number of active server pages are operable on the remote clients and the server clusters to proceed through a the COM layer to verify or validate a POP code for purposes of issuing a value to an appropriate consumer account based on an entered reward code connected with at least one of the consumer goods manufacturer or service provider in the network of sponsoring companies. Another server 107, e.g. a domain name search server, is shown in FIG. 1B coupled to the networked infrastructure 100. Further, the networked infrastructure 100 can include an Extranet Server 109 containing a processor, a storage device and a number of linked web pages suitable for providing a demonstration of the networked infrastructure's 100 reward service capabilities to the remote clients.

FIG. 2 is a diagram of a hardware and operating environment in conjunction with which embodiments of the invention may be practiced for the server clusters, one or any number of remote clients 104-1, 104-2, . . . , 104-N, and the additional servers and systems 106-1, . . . , 106-N from FIG. 1. The description of FIG. 2 is intended to provide a brief, general description of suitable computer hardware and a suitable computing environment in conjunction with which the invention may be implemented. The invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by remote processing devices that are linked through a communications network. In a distributed computing environment, program modules may be located in both local and remote memory storage devices.

In the embodiment shown in FIG. 2, the hardware and operating environment of the servers and/or the remote clients from FIG. 1 includes a general purpose computing device in the form of a personal computer 20, or a server 20, including a processing unit 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 can be any of several types of bus structures including a memory bus or memory controller, a peripheral bus, and a local bus using any of a variety of bus architectures. The system memory can also be referred to as simply the memory, and includes read only memory (ROM) 24 and random access memory (RAM) 25. a basic input/output system (BIOS) 26, containing the basic routines that help to transfer information between elements within the computer 20, or a server 20, such as during start-up, may be stored in ROM 24. The computer 20, or a server 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20, or a server 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, can be used in the exemplary operating environment.

A number of program modules can be stored on the hard disk, magnetic disk 29, optical disk 31, ROM 24, or RAM 25, including an operating system 35, one or more application programs 36, other program modules 37, and program data 38. a plug in containing a search engine for the present invention can be resident on any one or number of these computer-readable media.

A user may enter commands and information into the personal computer 20, or server 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

As explained in connection with FIG. 1, the computer 20, or server 20 may operate in a networked environment using logical connections to one or more remote computers or servers, such as remote computer 49. These logical connections are achieved by a communication device coupled to or a part of the computer 20, or server 20; the invention is not limited to a particular type of communications device. The remote computer 49 can be another computer, a server, a router, a network PC, a client, a peer device or other common network node, and typically includes many or all of the elements described above relative to the computer 20, or server 20, although only a memory storage device 50 has been illustrated in FIG. 2. The logical connections depicted in FIG. 2 include a local area network (LAN) 51 and a wide area network (WAN) 52. Such networking environments are commonplace in office networks, enterprise-wide computer networks, intranets and the Internet, which are all types of networks.

When used in a LAN-networking environment, the computer 20, or server 20, is connected to the LAN 51 through a network interface or adapter 53, which is one type of communications device. When used in a WAN-networking environment, the computer 20, or server 20, typically includes a modem 54, a type of communications device, or any other type of communications device, e.g. a wireless transceiver, for establishing communications over the wide area network 52, such as the Internet; the invention is not so limited. The modem 54, which may be internal or external, is connected to the system bus 23 via the serial port interface 46. In a networked environment, program modules depicted relative to the personal computer 20, or portions thereof, can be stored in the remote memory storage device 50 of remote computer, or server 49. It is appreciated that the network connections shown are exemplary and other means of and communications devices for establishing a communications link between the computers may be used.

The hardware and operating environment in conjunction with which embodiments of the invention may be practiced has been described. The computer 20, or server 20, in conjunction with which embodiments of the invention can be practiced can be a conventional computer, a distributed computer, or any other type of computer; the invention is not so limited. Such a computer 20, or server 20, typically includes one or more processing units as its processor, and a computer-readable medium such as a memory. The computer 20, or server 20, can also include a communications device such as a network adapter or a modem, so that it is able to communicatively couple to other computers, servers, or devices.

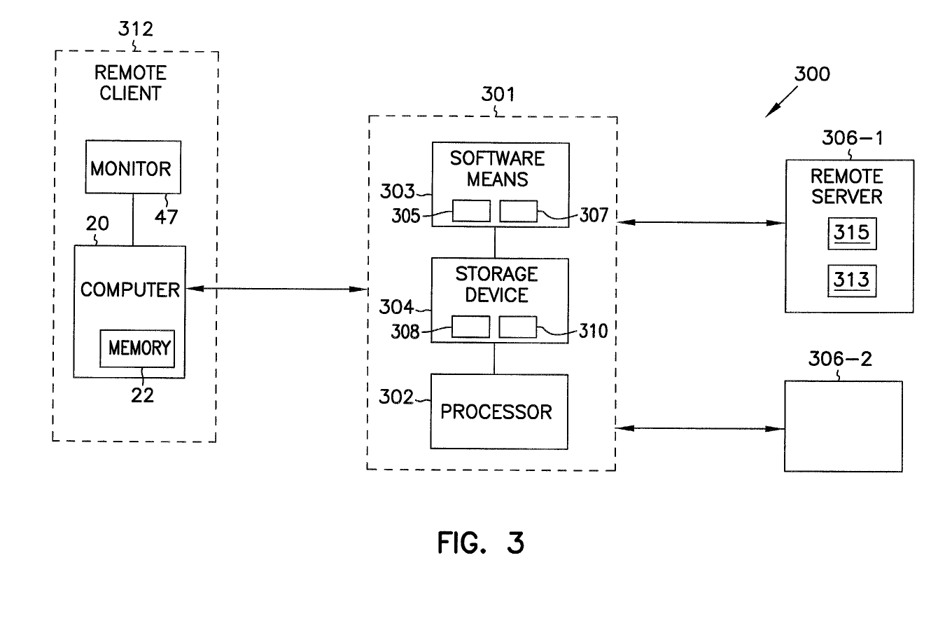

FIG. 3 is an illustration of another system level embodiment according to the teachings of the present invention. FIG. 3 is a intended to illustrate a more basic adaptation of the more detailed system 100 interactions shown in FIG. 1 B. In FIG. 3, the system 300 includes server 301. According to the present invention, server 301 is provided as an example, but not by way of limitation, for any one of the number of servers in the server clusters from FIG. 1B. In particular server 301 is described illustratively here as a representation of any one of the number of servers in the server clusters performing the functions of the present invention. As described in connection with FIG. 1B, the server 301 includes a processor 302 coupled to a storage device 304. The system further includes software means 303 operative on the processor 302, the remote client having a client program, and the additional servers and systems 306-1, 306-2, etc, to perform methods according to the teachings of the present invention. The software means includes a number of software programs, including interface protocols, for carrying out the methods of the present invention. According to the teachings of the present invention, the software means includes a reward analysis module 305 executable on the server clusters to define the business rules of a reward program, e.g. perform fraud analyses, check dates and proof of purchase codes (POP). Also, according to the teachings of the present invention, the software program includes a reward program module 307 for creating a reward program for one or more consumer products for one or more sponsor/reward offerers. These reward programs can then be executed on server 301 in the server clusters. As one of ordinary skill in the art will understand upon reading this disclosure, a particular reward program can be launched in cooperation with the reward analysis module 305 based on a reward code or program code received from remote client/member user 312. In one embodiment, the reward code can be received online from the remote client 312 when the remote client 312 connects with a number of active server pages through a reward program web site on server 301. The reward program launched from the reward program module 307 executable on server 301 defines the types of rewards possible, and will be used by the reward analysis module 305 to perform reward processing, e.g. authentication and verification, and manage a remote client/member user's experience with a reward offer over the life cycle of the reward program. In other words, a reward program will interact with a reward analysis module 305 as executed on server 301 to define the business rules of the reward offer.

The software programs according to the teachings of the present invention will be executing on system 300. The software means 303 can be resident on the server as shown in FIG. 3, or alternatively, the software means can be resident on any number of the storage devices, e.g. computer readable medium, coupled in system 300. One of ordinary skill in the art will understand the manner in which a software program can be launched from a computer readable medium in a computer based system to execute the functions defined in the software program. One of ordinary skill in the art will further understand the various programming languages which may be employed to create a software program designed to implement and perform the methods of the present invention. In one embodiment, much of the application software is implemented using object oriented programming, hyper-text mark-up language (HTML) and the like. However, the teachings of the present invention are not limited to a system using object oriented programming and no embodiment of the invention is limited to a particular programming language or environment.

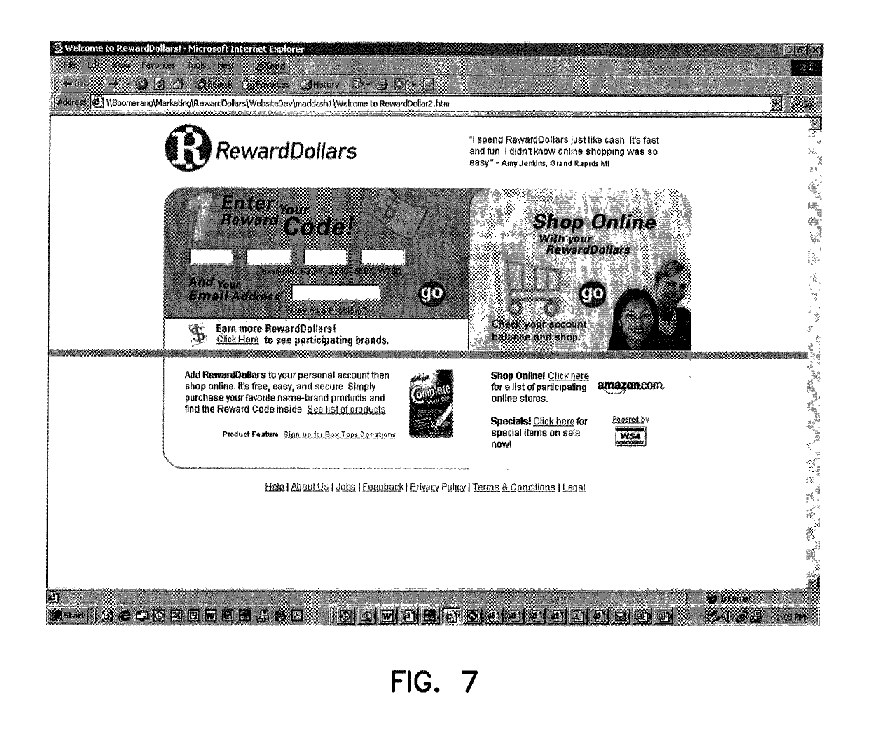

In one embodiment of system 300, the system facilitates Internet reward services for any number of consumer product (CPG) manufacturers, service providers and retailers who are participating in a network of Sponsors according to the teachings of the present invention. In this embodiment, the server 301 includes a database of valid reward codes 308, which can be obtained from the server clusters for the particular reward program which has been launched. According to the teachings of the present invention, the server 301 further includes a database for a network of consumer products manufacturers, service providers and (CPG) retailers/manufacturers (Sponsors), a number of consumer accounts, and a number of partnered or subscriber e-tailers. The invention includes a portal (shown in FIG. 7) maintained on a client interface server from among the cluster of servers as shown and described in more detail in connection with FIG. 1B. In the invention, the portal is downloadable and displayable to a remote client having a graphical user interface. Also, according to the teachings of the present invention, the portal provides access to a number of active server pages which communicate with the server 301. The invention includes software means 303 operable on the server 301 and the number of active server pages (illustrated in FIGS. 7-11) for receiving a reward code. The software means are further operable for verifying a validity of the reward code as against the database of valid reward codes for the network of Sponsors, and crediting an appropriate one of the number of consumer accounts with a value, once the validity of the reward code is verified.

The software means operable on the server and the number of active server pages is operable for establishing a new consumer account. Here, establishing a new consumer account includes collecting a set of user specific data as illustrated in the number of active server pages shown in FIGS. 7-11. Collecting a set of user specific data includes collecting a set of user specific data selected from the group consisting of a user name, a user identification, a user email account address, a user commercial credit card number, and a user password. The portal of the present invention further provides access to a number of partnered or subscriber e-commerce retailers. According to the teachings of the present invention, the software means is further operable for debiting a value from a consumer account in connection with making an online purchase.

According to the teachings of the present invention, the software means operable for crediting an appropriate one of the number of consumer accounts is further operable for adding value amounts to an appropriate one of the number of consumer accounts for reward codes received. In this manner, value can be added to a consumer account from multiple reward codes accumulated across multibrands or multiple goods and services within a brand family (e.g., the Sponsor) to use at a member user's discretion. In one embodiment, the software means operable for crediting an appropriate one of the number of consumer accounts with a value includes crediting a consumer account with a value proprietary to the system, wherein the value is equivalent to physical currency. According to the teachings of the present invention, the network of consumer goods manufacturers/service providers and retailers (Sponsors) stored in the server database includes a network of non-competitive Sponsors, or multiple brands from a single consumer goods manufacturer.

Thus, as one of ordinary skill in the art will understand upon reading this disclosure, the present invention provides a system for facilitating an Internet reward program in association with a network of non-competing consumer products manufacturer Sponsors. According to the teachings of the present invention, the software means tracks members user's purchasing habits across various products and services and records the same in a database based on the reward codes entered by member users. Member users are attracted to use the system's architecture since they can accumulate account value across multiple products and services and not just within a single class or family. In this manner, a manufacturer of consumer products manufacturer or service provider can pool resources with other non-competing manufacturer's to better target promotional, advertising, and marketing activities. This results in correctly targeting, growing, and improving the manufacturer's best customer base. Using the present invention the manufacturer no longer is offering rewards with a single product promotion, but rather as part of a larger network. The member user can then elect to spend the value in their consumer account across a wide range of additional Sponsor products or the network of partnered/subscriber e-tailers.

As mentioned above, an embodiment of a portal 700 according to the teachings of the present invention is provided in FIG. 7. According to the teachings of the present invention, software means is operable on the server and the number of active server pages for receiving a reward code associated with one of the network of consumer product sponsors. As shown in FIG. 7, an active field 710 is provided on an active server page such that a remote client/member user can enter the reward code associated with one of the Sponsors in the network of consumer products companies. The software means as described above is operable for verifying a validity of the reward code as against the database of valid reward codes for the network of consumer products/service sponsors. The software means is further operable for crediting an appropriate one of the number of consumer accounts with a value when the validity of the reward code is verified. Further, the software means is operable for debiting an appropriate value from a consumer account in connection with making an online purchase. The embodiment shown in FIG. 8 illustrates a number of embedded links, as the same are know and understood in the art, which can be used by the remote client/member user to access online shopping through a number of subscriber online retailing partners or a number of other consumer product manufacturers in the network of consumer product manufacturers according to the teachings of the present invention.

As mentioned above, the software means, operable for crediting an appropriate one of the number of consumer accounts with a value when the validity of the reward code is verified, includes storing a number of accumulated values in a consumer account. In the invention, the number of accumulated values are received from a number of reward codes associated with a number of different consumer products/services within the network of consumer product sponsors. Also, according to the teachings of the present invention, the software means operable for crediting an appropriate one of the number of consumer accounts with a value is further operable for crediting an additional value to the consumer account from a member user's commercial credit card account such that a user can supplement a value in the consumer account in order to complete an online purchase. Thus, in one embodiment, the software means operable for debiting the value from a consumer account in connection with making an online purchase is further operable for debiting a value from a member user's commercial credit card account.

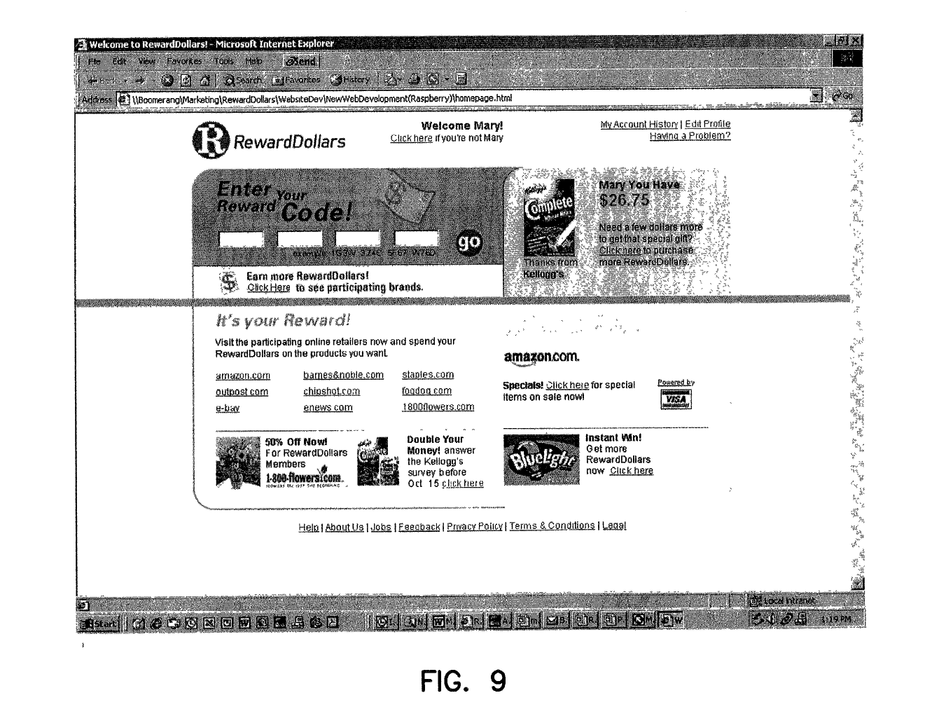

In one embodiment of the present invention as shown in FIG. 9, the number of active server pages further include a number of overlays for games and sweepstakes shown generally at 910. One of ordinary skill in the art will understand upon reading this disclosure the manner in which the number of overlays for games and sweepstakes can be provided on an active server page. Also, the present invention is further operable for issuing a number of Sponsor reward certificates which a member user can immediately apply to online transactions.

According to the teachings of the present invention, debiting the value from a consumer account in connection with making an online purchase includes collecting data associated with the online purchase. In this embodiment, collecting data associated with the online purchase includes storing the collected data in the database of the server such that the collected data can be analyzed and shared between a network of manufacturers/retailers having products in the network of consumer product manufacturers, as well as between a subscriber network of online electronic commerce retailers. Thus, according to the teachings of the present invention, the software means operable for verifying a validity of the reward code as against the database of valid reward codes for the network of consumer product/service sponsors is further operable for associating a reward activity process with a particular consumer account.

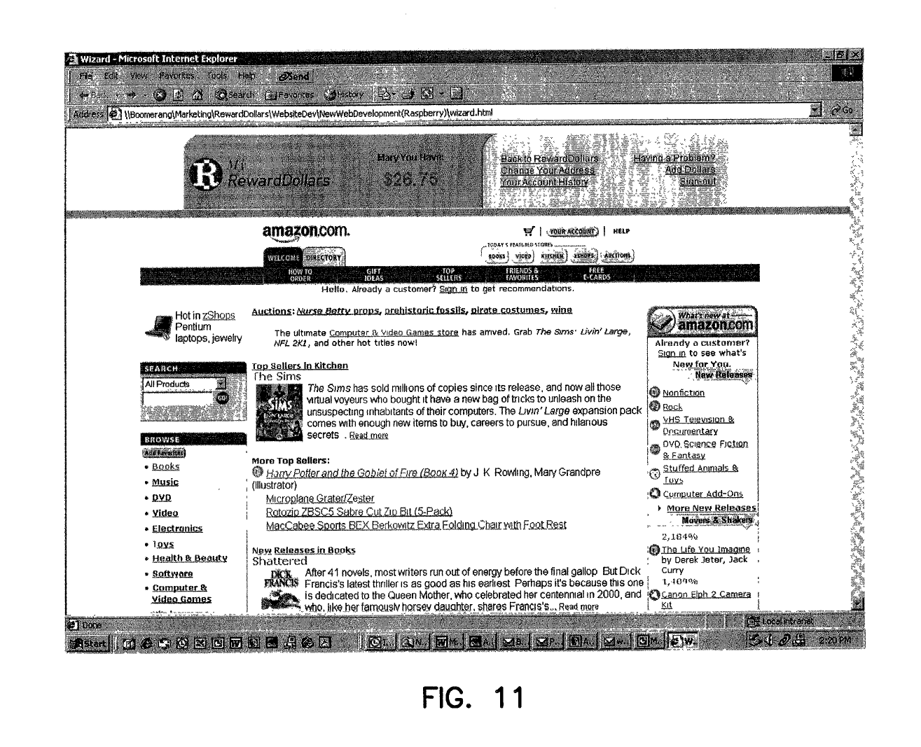

As shown in the embodiment of FIG. 11, the software means operable on the portal further provides access to a number of partnered or subscriber e-commerce retailers. The present invention facilitates an online shopping process through a number of pass through servers in connection with the number of active server pages such that a user can complete an online transaction using the value credited in a member user's consumer account.

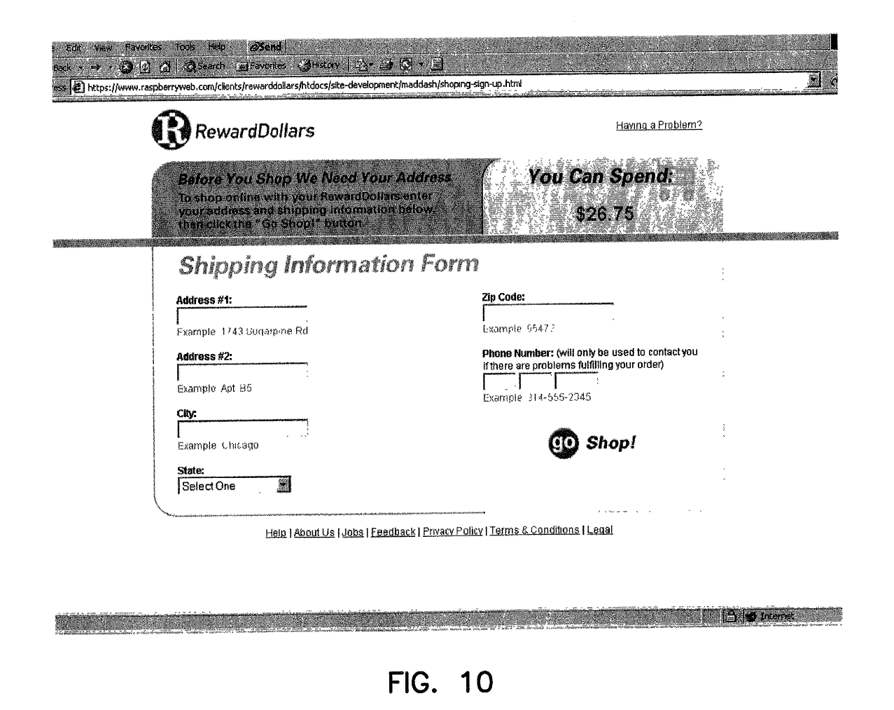

As will be understood by one of ordinary skill in the art upon reading this disclosure, the number of active server pages, as shown in FIG. 8 and 10, are used to acquire a requisite set of information data from a remote client/member user. All of this data collected on a member user is associated with a consumer account. As mentioned above, the present invention facilitates an easier “check-out” process than is available through traditional online shopping mechanisms. This is due to the fact that the software means operable on the system's architecture can pull all of this member user data to complete an online transaction when the member user is making an online purchase with a partnered e-tailed in the system in conjunction with the number of active server pages through the pass-through servers. The software means makes only the necessary data available to an e-commerce retailer such that a user can complete the online transaction without physically supplying any additional user information at a time when the transaction is completed. Also, as shown in the embodiments of FIGS. 9-11, the number of active server pages provide a member user with a displayable set of information relating to a consumer account balance, a consumer account number, and a consumer account detail description during a member user's experience with the system.

As one of ordinary skill in the art will understand upon reading this disclosure, the system's architecture provides a number of cross-promotional opportunities, value-added promotions, and online subscription offerings which can be selected at a remote client/member user. This affords the remote client/member user the opportunity to receive additional rewards in the same manner described herein. Also, as one of ordinary skill in the art will understand, the number of active server pages can further include advertising which allows the Sponsors and partnered e-tailers to generate advertising revenues. Further, as one of ordinary skill in the art will understand upon reading this disclosure, the system provides a method for partnered online retailers to gain extensive off-line exposure, obtain new-to-file customers at a dramatically lower acquisition cost, and develop loyal customers with online values to spend.

### Methods according to the Present Invention

As explained in connection with FIGS. 1A, 1B, 2, and 3, the present invention is implemented using computer based systems which have computer readable medium for executing instructions from software means, e.g. programs, for carrying out the above described embodiments. These embodiments include methods for facilitating Internet reward services for a network of consumer product/service Sponsors and a network of partnered e-tailers. These embodiment further include methods for offering value-added online promotions, games and sweepstakes. The scope of the present invention includes other method embodiments which will be understood by one of ordinary skill in the art upon reading this disclosure.

The system explained in connection with FIGS. 1A, 1B, 2, and 3, comprises a processor, a storage device coupled to the processor, and software means operative on the processor, e.g. system collectively, for providing Internet reward services to facilitate consumer purchase loyalty. The system, software program, and program modules will enable the methods described below.

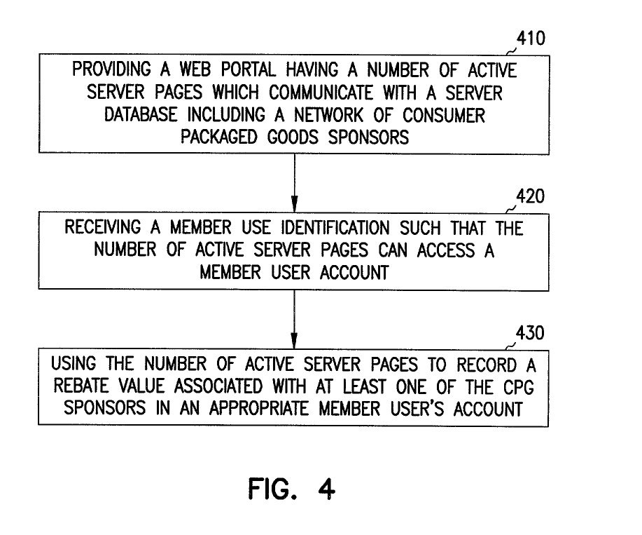

FIG. 4 is a flow chart illustrating one method embodiment for Internet reward services according to the teachings of the present invention. The method embodiment provided in FIG. 4, incorporates the software means having computer executable instructions described above. The method shown in FIG. 4 includes providing a web portal having a number of active server pages, wherein the number of active server pages communicate with a server database including a network of consumer product/service sponsors 410. The method includes receiving a member user identification such that the number of active server pages can access a member user account 420. And, the method further includes using the number of active server pages to record a reward value in the member user's account 430.

In the embodiment of FIG. 4, using the number of active server pages to record a reward value in the consumer account further includes receiving a reward code associated with at least one of the consumer product/service sponsors in the network of consumer products/service sponsors. The method includes verifying the validity of the reward code against a database of valid reward codes for the network of consumer product/service sponsors. The method further includes crediting the member user's account with a value once the reward code is verified.

As one of ordinary skill in the art will understand upon reading this disclosure, crediting the consumer account with a value includes crediting the member user's account with a number of additional value amounts for a number of reward codes received in connection with a number of different consumer product/services as provided by the network of consumer product/service sponsors.

In one embodiment of FIG. 4, the number of reward codes received in connection with a number of different consumer products/services are associated with a number of different consumer products/services for a number of different, non-competitive consumer products retailers in the network of consumer product/service sponsors. In an alternative embodiment of FIG. 4, the number of different reward codes received in connection with a number of different consumer products/services are associated with a number of different consumer product/services for a single consumer retailer in the network of consumer product/service sponsors.

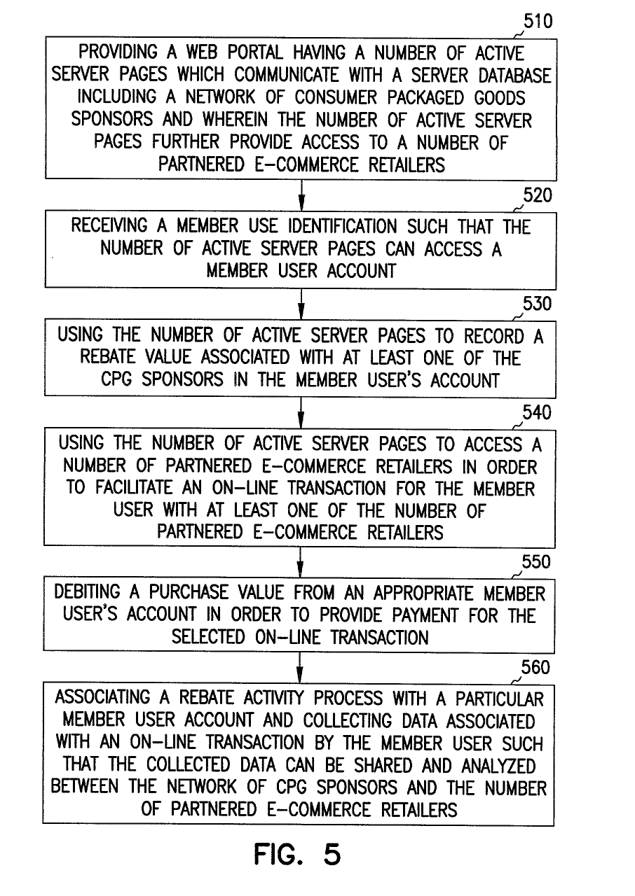

FIG. 5 is a flow chart illustrating one method embodiment for Internet reward services according to the teachings of the present invention. The method embodiment provided in FIG. 5, incorporates the software means having computer executable instructions described above. The method shown in FIG. 5 includes providing a web portal having a number of active server pages, wherein the number of active server pages communicate with a server database including a network of consumer product/service sponsors and wherein the number of active server pages further provide access to a number of partnered e-commerce retailers 510. The method includes receiving a member user identification such that the number of active server pages can access a member user account 520. And, the method further includes using the number of active server pages to record a reward value in the member user's account 530.

In the embodiment of FIG. 5, using the number of active server pages to record a reward value in the consumer account further includes receiving a reward code associated with at least one of the consumer product/service sponsors in the network of consumer product/service sponsors. The method includes verifying the validity of the reward code against a database of valid reward codes for the network of consumer product/service sponsors. The method further includes crediting the member user's account with a value once the reward code is verified.

In the embodiment of FIG. 5, the method further includes using the number of active server pages to access a number of partnered e-commerce retailers in order to facilitate an on-line transaction for the member user with at least one of the number of partnered e-commerce retailers 550. In the embodiment of FIG. 5, using the number of active server pages to access the number of partnered e-commerce commerce retailers includes providing access to the number of partnered e-commerce commerce retailers through a number of pass through servers. The method includes using the number of active server pages to select an on-line transaction with one or more of the number of partnered e-commerce retailers. As shown in FIG. 5, the method includes debiting a purchase value from an appropriate member user's account in order to provide payment for the selected on-line transaction 550. According to the teachings of the present invention, debiting a purchase value from the member user's account in order to provide payment for the selected on-line transaction includes using the number of active server pages to access a member user's commercial credit card account in order to provide an additional value to the member user's account.

In the embodiment of FIG. 5, the method further includes associating a reward activity process with a particular member user account and collecting data associated with an on-line transaction by the member user such that the collected data can be analyzed and shared between the network of consumer product/service sponsors and the number of partnered e-commerce retailers 560.

As one of ordinary skill in the art will understand upon reading this disclosure, the method of the present invention further includes establishing a new member user account where establishing a new member user account includes collecting a set of member user specific data. In the invention, collecting a set of user specific data includes collecting a set of user specific data selected from the group consisting of a user name, a user identification, a user email account number, a user commercial credit card number, and a user password.

As mentioned above, the methods of the present invention include enabling a consumer product/service sponsor reward offerer to cross promote a store purchased item with a number of products available from e-commerce retailers. In this manner, the present invention affords the opportunity to increase a consumer's perceived value and satisfaction with the sponsor. As one of ordinary skill in the art will understand upon reading this disclosure, the present invention further enables Sponsors in the network of sponsors to generate cross-promotional revenues. The methods of the present invention further increase a member user's one-on-one interaction with a Sponsor in the network of consumer products/services sponsors.

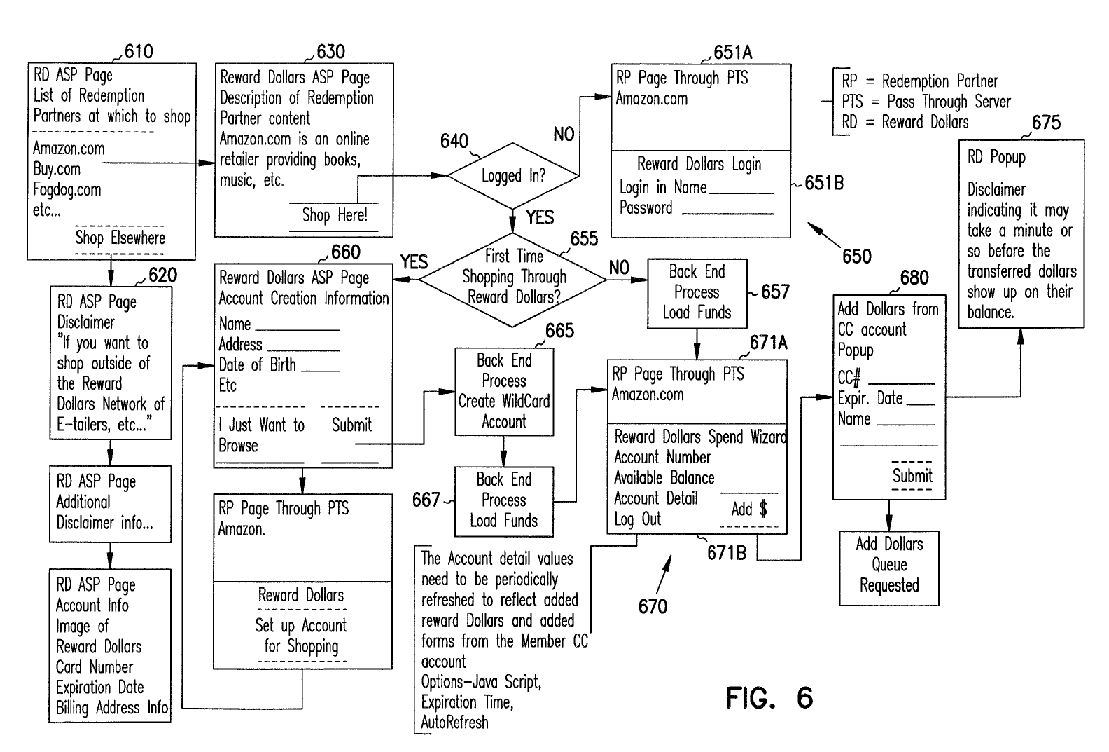

FIG. 6 is a flow chart diagram illustrating one embodiment of a method for facilitating Internet reward services using a number of active server pages according to the teachings of the present invention. As shown in FIG. 6, the method includes a remote client accessing a proprietary website or portal having access to a number of active server pages. According to the embodiment shown in FIG. 6, a remote client/member user can access the number of active server pages through the proprietary website or portal at 610. A representative screen shot of such a portal according to the teachings of the present invention is provided in FIG. 7. The active server page shown at 610 provides a remote client/member user with a list of redemption partners, e.g. a network of partnered e-commerce retailers, or e-tailers, at which the remote client/member user can conduct online consumer transactions through a number of pass-through servers as explained above. As shown in the embodiment of the invention provided in FIG. 6, a remote client/member user can optionally select one of the redemption partners to access another active server page, e.g. 620, which has a description of the redemption partner's (e.g., partnered e-tailed) content.

In the alternative to shopping in the proprietary, 's system's architecture of the present invention, a remote client/member user can optionally select a link on the active server page 610 in order to shop online outside of the present invention's network of on-line retailers. In the embodiment shown in FIG. 6, an active server page 620 is provided to the remote client/member user offering a disclaimer for shopping outside of the subscriber network of on-line retailers. However, as mentioned above, a remote client/member user will experience a more greatly enhanced and streamlined online shopping experience (using the functionality of the shopping inside the system's architecture) than that which is experienced using conventional online shopping mechanisms. As shown in FIG. 6, the active server page 610 allows the user to optionally select a link to access online shopping from a subscriber online redemption partner (partnered e-tailed). Upon doing so, the remote client/member user is provided with an active server page 630 which displays the content of the partnered e-tailed. A screen shot illustrating the same is provided in FIG. 11. In one embodiment, selecting a link to access online shopping from the subscriber online redemption partner will prompt the system to verify whether the remote client/member user is logged into the system at 640.

According to the teachings of the present invention, in the embodiment shown in FIG. 6, if a remote client/member user is not logged into the system, an active server page 650 is provided which can facilitate a log-in process for the remote client/member user. As shown in FIG. 6, the one embodiment of active server page 650 includes at least a two part display 651A and 651B. In portion 651A of the embodiment shown in FIG. 6, a portion of a web page for the subscriber online redemption partner/subscriber e-tailed is provided. As one of ordinary skill in the art will understand upon reading this disclosure, the portion 651A is accessed through a pass-through-server on the system's architecture as the same has been described in more detail above. In portion 651B a remote client/member user is provided with an opportunity to enter a log-in name and a password as the same are known and understood by one of ordinary skill in the art.

According to the teachings of the present invention, if the remote client/member user is already logged in, then a link can be selected indicating whether the remote client/member user is using the system's architecture for a first time to conduct online shopping. An example of an active server page illustrating the same according to the teachings of the present invention is provided in FIG. 8. Alternatively, the software means operating on the system can include functionality to determine whether the remote client/member user is shopping through the system for the first time based on the remote client/member user provided log-in information. Such a decision step is shown at 655.

As shown in the embodiment of FIG. 6, if the remote client/member user is not shopping through the system for the first time, then the system uses the software means to load available information, relating to the remote client/member user, to the number of active server pages at 657 from the database storage device as explained in more detail above. An example of an active server page illustrating the remote client/member user's name and the value in their consumer account is provided in FIG. 9. According to the teachings of the present invention, the information available relating to the remote client/member user includes information concerning a value of available finds in a consumer account associated with that remote client/member user.

According to the teachings of the present invention, the value of available funds in a consumer account results from the remote client/member user having entered a number of reward codes associated with a number of consumer product/services within a subscriber network of sponsors. The same will be known and understood by one of ordinary skill in the art upon reading this disclosure.

The embodiment shown in FIG. 6 illustrates an active server page 660 which is downloadable and displayable to a remote client/member user when the software means operating on the system determines that the remote client/member user is a first time shopper on the system's architecture. As shown in FIG. 6, active server page 660 provides a remote client/member user with an opportunity to create an individual consumer account within the system's architecture. In the embodiment shown in FIG. 6, active server page 660 includes a request for remote client/member user information selected from the group consisting of a member user's name, address, date of birth, etc. The same can be interpreted and operated on by the software of the present invention. The above list is intended to be illustrative and not exhaustive of the type of information which the system can gather from a remote client/member user in order to set up a consumer account as the same will be known and understood by one of ordinary skill in the art.

Also, shown in the embodiment of the active server page 660 is the optionality to select a link which permits the remote client/member user to continue browsing through the pass-through-server without entering the above described information for a consumer account creation.

However, as one of ordinary skill in the art will understand upon reading this disclosure, the above described information must be entered into the system's architecture before the system will facilitate the remote client/member user completing an online transaction within the system. Again, as mentioned above, a remote client/member user will always have the optionality of going outside the system's architecture for conduction of online transactions, but the same will cost the remote client a measurable degree of efficiency.

In one embodiment of the present invention, as shown in FIG. 6, a remote client/member user can proceed from newly establishing a consumer account to conducting and completing an online consumer transaction. According to the teachings of the present invention, an optionally selectable link on active server page 660 will instruct the software means to process the new consumer account request. In one embodiment, as shown in FIG. 6, the software means can create a “virtual stored value” account at 665 for the remote client/member user in which case the system loads “virtual stored value” funds at 667 into a new consumer account.

According to the teachings of the present invention, the present invention includes a number of active server pages which facilitate an enriched online shopping experience for the remote client/member user. As mentioned above, and as will be discussed in more detail below, the screen shot embodiments shown in FIGS. 7-11 provide a sampling of the online shopping functionality accorded by the present invention. In active server page (ASP) 670, the ASP again is presented as an embodiment which includes at least a two part display, 671A and 671B. In the embodiment shown in FIG. 6, the top portion 671A again includes a description of a subscriber redemption partner/subscriber e-tailed selected by the remote client/member user to complete an online transaction through a pass through server in the system's architecture. One of ordinary skill in the art will appreciate and understand the same in view of reading this disclosure.

As shown in the embodiment of FIG. 6, the bottom portion 671B includes a portion showing a set of information relating to the remote client/member user. Again, the screen shot embodiments of the active server pages in FIGS. 7-11, discussed herein, provide some added detail concerning embodiments for displayable information relating to the remote client/member user. The active server page 670 shown in FIG. 6, represents a set of remote client/member user information selected from the group consisting of a consumer account number, an available balance or value in the consumer account, and an account detail for the remote client/member user. As one of ordinary skill in the art will understand upon reading this disclosure, each of these features can include optionally selectable links for retrieving added layers of detail and information in the form of additional active server pages. One of ordinary skill in the art will know and understand upon reading this disclosure the manner in which the software means can provide the operability to achieve the functionality described herein. That is, the software means of the present invention can be written in various programming languages to facilitate the methods and inventive functionality described herein. In one embodiment of the present invention, portion 671B of active server page 670 is referred to as a “spend wizard” content.

Another aspect of the present invention which illustrates the manner in which the number of active server pages can facilitate an enriched online shopping experience is demonstrated by ASP 680. Active server page 680 illustrates the manner in which the present invention can be used to add a value to an appropriate consumer account from a remote client/member user's commercial credit card account. In this manner, a remote client/member user can debit a value from their commercial credit card account and supplement a value in their consumer account in order to complete an online transaction with one of the subscriber redemption partners/subscriber e-commerce retailers. As one of ordinary skill in the art will understand upon reading this disclosure, the software means of the present invention can operate to add value to the consumer account using the Application Process Servers 102-2, as discussed above in connection with FIG. 1B, and facilitate the completion of the online transaction by incorporating much of the remote client/user member information into an online “check out” process with the subscriber e-tailed so that the remote client/member user does not have to re-enter the same. The same has been provided in greater detail above. As one of ordinary skill in the art will understand upon reading this disclosure, the ability to incorporate the remote client member user's information into the check out process results from the remote client/member user shopping on line through the pass-through servers in the system's architecture. One of ordinary skill in the art will further understand the member user, according to the teachings of the present invention, is able to pool a value in the member user's account accumulated from entering reward codes from any of the multiple consumer product manufacturer or service providers in the network of sponsors. Another active page 690 illustrates that in the embodiment of FIG. 6, additional disclaimer pages be included which keep the remote client/member user apprised of system operations, e.g. a time period for the commercial credit card balance to appear in the consumer account.

As one of ordinary skill in the art will understand upon reading this disclosure certain blocks represented in the embodiment of FIG. 6 represent functions performed by the software means of the present invention which occur transparent to the remote client/member user.

FIGS. 7-11 illustrate screen shots embodiments for some of the active server pages according to the teachings of the present invention. The same is provided by way of illustration only. The invention is not so limited, and one of ordinary skill in the art will understand that other screen shot images for a number of active server pages can be created which accord the methods of the present invention. FIGS. 7-11 illustrate one embodiment for the a portal of the present invention which is maintained on a client interface server and is downloadable and displayable to a member user at a remote client having a graphical user interface. According to the teachings of the present invention, the number of active server pages communicate with one or more servers on the system and further provide access to a number of partnered e-commerce retailers through a number of pass through servers.

### Conclusion

Thus, systems and methods have been described through which consumer product manufacturers service providers and retailers can afford greater flexibility for consumers to purchase through traditional retail venues or on-line and receive a more direct perceived value from reward offerings. Members have flexibility in the ways in which they can earn a value in their consumer accounts from entering reward codes received from consumer product manufacturers and service providers in the network of Sponsors. For example, members can earn value from purchases made at bricks and mortar retail locations, online purchase transactions, and through bonus sweepstakes or game overlays. According to the teachings of the present invention, Members also have flexibility in the manner in which they spend value accumulated in their consumer accounts. In the present invention, conducting online transactions is simplified and streamlined. The present invention further reduces a reward offerer's sponsor's processing costs, and then gives the reward offerer an added opportunity for cross promotion with a number of products offered online via on-line e-commerce retailers. The reward mechanism of the present invention further increases reward circulation reach and affords these benefits without requiring direct active involvement from product retailers.

What is claimed is:

1. A system facilitating Internet retail services, comprising:
a server, wherein the server includes a database of valid reward codes for a network of consumer product good/manufacturer's and service providers, and a number of consumer accounts;
a portal maintained on a client interface server, which is downloadable and displayable to a remote client having a graphical user interface, and wherein the portal provides access to a number of active server pages which communicate with the server; and
software means operable on the server and the number of active server pages for:
receiving a reward code;
verifying a validity of the reward code as against the database of valid reward codes for the network of consumer product good/manufacturer's and service providers; and
crediting an appropriate one of the number of consumer accounts with a value when the validity of the reward code is verified.

2. The system of claim 1, wherein the software means operable on the server and the number of active server pages is operable for establishing a new consumer account.

3. The system of claim 2, wherein establishing a new consumer account includes collecting a set of user specific data.

4. The system of claim 3, wherein collecting a set of user specific data includes collecting a set of user specific data selected from the group consisting of a user name, a user identification, a user email account number, a user commercial credit card number, and a user password.

5. The system of claim 1, wherein the portal further provides access to a number of partnered e-commerce retailers, and wherein the software means is further operable for debiting a value from a consumer account in connection with making an on-line purchase at one of the partnered e-commerce retailers.

6. The system of claim 1, wherein the software means operable for crediting an appropriate one of the number of consumer accounts is further operable for adding a number of additional value amounts to an appropriate one of the number of consumer accounts for a number of additional reward codes entered.

7. The system of claim 6, wherein the number of additional reward codes entered are associated with a number of different consumer products/service sponsors for a number of different, non-competitive consumer product manufacturers and/or service providers in the network of sponsors.

8. A system facilitating Internet retail services, comprising:
a server, wherein the server includes a database of valid reward codes for a network of consumer product/service sponsors, and a number of consumer accounts;
a portal maintained on a client interface server, which is downloadable and displayable to a remote client having a graphical user interface, and wherein the portal provides access to a number of active server pages which communicate with the server; and
software means operable on the server and the number of active server pages for:
receiving a reward code;
verifying a validity of the reward code as against the database of valid reward codes for the network of consumer product/service sponsors;
crediting an appropriate one of the number of consumer accounts with a value when the validity of the reward code is verified; and
adding a number of additional value amounts to an appropriate one of the number of consumer accounts for a number of additional reward codes received when the number of additional reward codes are verified.

9. The system of claim 8, wherein the number of additional reward codes entered are associated with a number of different consumer products or services for a single consumer products sponsor in the network.

10. The system of claim 8, wherein the software means operable for crediting an appropriate one of the number of consumer accounts with a value includes crediting the consumer account with a value proprietary to the system.

11. The system of claim 10, wherein the value proprietary to the system is a value equivalent to physical currency.

12. The system of claim 8, wherein the network of consumer products and/or services stored in the server database includes a network of non-competitive consumer products manufacturers and service providers.

13. A system facilitating Internet retail services, comprising:
a server, wherein the server includes a database of valid reward codes, a network of consumer products manufacturers/service providers, and a number of consumer accounts;
a portal maintained on a client interface server, which is downloadable and displayable to a remote client having a graphical user interface, wherein the portal provides access to a number of active server pages which communicate with the server, and wherein the portal further provides access to a number of partnered e-commerce retailers; and
software means operable on the server and the number of active server pages for:
receiving a reward code associated with one of the network of sponsoring companies;
verifying a validity of the reward code against the database of valid reward codes for the network of sponsoring companies;
crediting an appropriate one of the number of consumer accounts with a value when the validity of the reward code is verified; and
debiting a value from the appropriate one of the number of consumer accounts in connection with making an on-line purchase.

14. The system of claim 13, wherein debiting a value from the appropriate one of the number of consumer accounts in connection with making an on-line purchase includes only debiting a value when an on-line purchase is made through one of the number of partnered e-commerce retailers.

15. The system of claim 13, wherein crediting an appropriate one of the number of consumer accounts with a value when the validity of the reward code is verified includes storing an accumulated value in the consumer account, wherein the accumulated value represents a number of values entered in connection with a number of different reward codes.

16. The system of claim 15, wherein the number of different reward codes entered are associated with a number of different consumer products and/or services for a number of different, non-competitive consumer products manufacturers and service providers in the network of sponsoring companies.

17. The system of claim 15, wherein the number of different reward codes entered are associated with a number of different consumer products or services for a single consumer products manufacturer or service provides in the network of sponsoring companies.

18. The system of claim 13, wherein the software means operable for crediting an appropriate one of the number of consumer accounts with a value is further operable for crediting an additional value to the consumer account from a member user's commercial credit card account.

19. The system of claim 18, wherein crediting an additional value to the consumer account from the member user's commercial credit card account includes supplementing the value in the consumer account for purposes of completing an online transaction with one of the number of partnered e-commerce retailers.

20. A system facilitating Internet retail services, comprising:
a server, wherein the server includes a database of valid reward codes, a network of consumer product and service sponsors, a number of member user accounts;
a portal maintained on a client interface server, which is downloadable and displayable to a remote client having a graphical user interface, wherein the portal provides access to a number of active server pages which communicate with the server, and wherein the portal further provides access to a number of partnered e-commerce retailers; and
software means operable on the server and the number of active server pages for:
receiving a reward code associated with one of the network of noncompetitive sponsoring companies;
verifying a validity of the reward code against the database of valid reward codes for the network of sponsoring companies;
crediting an appropriate one of the number of member user accounts with a value when the validity of the reward code is verified storing an accumulated value in the member user account, wherein the accumulated value represents a number of values entered in connection with a number of different reward codes; and
debiting a value from the appropriate one of the number of member user accounts in connection with making an on-line purchase when a purchase is made through one of the number of partnered e-commerce retailers.

21. The system of claim 20, wherein number of active server pages further includes a number of overlays for games and sweepstakes.

22. The system of claim 20, wherein receiving a reward code includes interpreting the reward code from a scanned bar code.

23. The system of claim 20, wherein the system is further operable for issuing a number of reward certificates.

24. The system of claim 23, wherein issuing a number of reward certificates includes issuing at least one reward certificate from a retailer.

25. The system of claim 23, wherein issuing a number of reward certificates includes issuing at least one reward certificate from one of the number of partnered e-commerce retailers.

26. A system facilitating Internet retail services, comprising:
a server, wherein the server includes a database of valid reward codes, a network of consumer product and service sponsors, a number of member user accounts;
a portal maintained on a client interface server, which is downloadable and displayable to a remote client having a graphical user interface, wherein the portal provides access to a number of active server pages which communicate with the server, and wherein the number of active server pages accessible through the portal further provide access to a number of partnered e-commerce retailers; and
software means operable on the server and the number of active server pages for:
receiving a reward code associated with one of the network of sponsors;
verifying a validity of the reward code against the database of valid reward codes for the network of sponsors;
crediting an appropriate one of the number of member user accounts with a value when the validity of the reward code is verified storing an accumulated value in the member user account, wherein the accumulated value represents a number of values entered in connection with a number of different reward codes;
debiting a value from the appropriate one of the number of member user accounts in connection with making an on-line purchase when a purchase is made through one of the number of partnered e-commerce retailers; and
collecting data associated with the on-line purchase.

27. The system of claim 26, wherein collecting data associated with the on-line purchase includes storing the collected data in the database of the server such that the collected data can be analyzed and shared between the network of consumer product/service sponsors and the number of partnered e-commerce retailers.

28. The system of claim 26, wherein the software means operable for verifying a validity of the reward code as against the database of valid reward codes for the network of consumer product/service is further operable for associating a reward activity process with a particular consumer account.

29. The system of claim 26, wherein the number of active server pages accessible through the portal which further provide access to a number of partnered e-commerce retailers facilitates an on-line shopping process with the number of partnered e-commerce commerce retailers through a number of pass through servers such that the member user can complete an on-line transaction using the value in the member user account.

30. The system of claim 29, wherein the number of active server pages which provide access to a number of partnered e-commerce retailers further provides a requisite set of information from the member user's account to a partnered e-commerce retailer such that the member user can complete the on-line transaction without physically supplying any additional member user information at a time when the transaction is completed.

31. The system of claim 26, wherein the number of active server pages further provide a member user with a displayable set of information relating to the member user account.

32. The system of claim 31, wherein the displayable set of information relating to the member user account includes a set of information selected from the group of a member user account balance, a member user account number, a member user account activity detail, and a member user transaction detail description.

33. A method for Internet retail services, comprising:
providing a web portal having a number of active server pages, wherein the number of active server pages communicate with a server database including a network of consumer product/service sponsors;
receiving a member user identification such that the number of active server pages can access a member user account; and
using the number of active server pages to record a reward value in the member user's account.

34. The method of claim 33, wherein using the number of active server pages to record a reward value in the consumer account further includes:
receiving a reward code associated with at least one of the consumer product/service sponsors in the network of consumer product/service sponsors;
verifying the validity of the reward code against a database of valid reward codes for the network of consumer product/service sponsors; and
crediting the member user's account with a value once the reward code is verified.

35. The method of claim 34, wherein crediting the consumer account with a value includes crediting the member user's account with a number of additional value amounts for a number of reward codes received in connection with a number of different consumer product/service provided by the network of consumer product/service sponsors.

36. The method of claim 33, wherein providing the web portal having access to the number of active server pages includes using the number of active server pages to access a number of partnered e-commerce retailers.

37. The method of claim 36, wherein using the number of active server pages to access a number of partnered e-commerce retailers includes:
providing access to the number of partnered e-commerce retailers through a number of pass through servers;
using the number of active server pages to select an on-line transaction with one or more of the number of partnered e-commerce retailers; and
debiting a purchase value from an appropriate member user's account in order to provide payment for the selected on-line transaction.

38. The method of claim 37, wherein debiting a purchase value from the member user's account in order to provide payment for the selected on-line transaction includes using the number of active server pages to access a member user's commercial credit card account in order to provide an additional value to the member user's account.

39. The method of claim 37, wherein debiting the purchase value from the appropriate member user's account in order to provide payment for the selected online transaction includes collecting data associated with the on-line purchase.

40. The method of claim 39, wherein collecting data associated with the on-line purchase includes storing the collected data in the server database such that the collected data can be analyzed and shared between the network of consumer product/service and the number of partnered e-commerce retailers.

41. A method for providing Internet retail services, comprising:
providing a web portal having a number of active server pages, wherein the number of active server pages communicate with a server database including a network of sponsors;
receiving a member user identification such that the number of active server pages can access a member user account; and
using the number of active server pages to record a reward value in the member user's account, wherein using the number of active server pages to record a reward value in the member user's account further includes:
receiving a reward code associated with a consumer packaged good included in the network of consumer product/service sponsors;
verifying the validity of the reward code against a database of valid reward codes for the network of consumer product/service sponsors; and
crediting an appropriate one of the member user's accounts with a value once the reward code is verified.

42. The method of claim 41, wherein crediting an appropriate one of the member user's accounts with a value includes crediting the member user's account with a number of additional value amounts for a number of reward codes received in connection with a number of different consumer product/service provided by the network of consumer product/service sponsors.

43. The method of claim 42, wherein the number of reward codes received in connection with a number of different consumer product/service are associated with a number of different consumer product/service for a number of different, noncompetitive consumer product/service retailers in the network of consumer product/service sponsors.

44. The method of claim 42, wherein the number of different reward codes received in connection with a number of different consumer product/service are associated with a number of different consumer product/service for a single consumer product/service retailer in the network of consumer product/service sponsors.

45. The method of claim 41, wherein providing the web portal having access to the number of active server pages includes using the number of active server pages to access a number of partnered e-commerce retailers.

46. The method of claim 45, wherein using the number of active server pages to access a number of partnered e-commerce retailers includes:
providing access to the number of partnered c-commerce retailers through a number of pass through servers;
using the number of active server pages to select an on-line transaction with one or more of the number of partnered e-commerce retailers; and
debiting a purchase value from an appropriate member user's account in order to provide payment for the selected on-line transaction.

47. The method of claim 46, wherein debiting a purchase value from the member user's account in order to provide payment for the selected on-line transaction includes using the number of active server pages to access a member user's commercial credit card account in order to provide an additional value to the member user's account.

48. The method of claim 47, wherein debiting the purchase value from the appropriate member user's account in order to provide payment for the selected online transaction includes collecting data associated with the on-line purchase.

49. The method of claim 48, wherein collecting data associated with the on-line purchase includes storing the collected data in the server database such that the collected data can be analyzed and shared between the network of consumer product/service and the number of partnered e-commerce retailers.

50. A method for providing Internet retail services, comprising:
providing a web portal having a number of active server pages, wherein the number of active server pages communicate with a server database including a network of consumer product/service sponsors, and wherein the number of active server pages further provide access to a number of partnered e-commerce retailers;
receiving a member user identification such that the number of active server pages can access a member user account;
using the number of active server pages to record a reward value in the member user's account, wherein using the number of active server pages to record a reward value in the member user's account further includes:
receiving a reward code associated with a consumer packaged good included in the network of consumer product/service sponsors;
verifying the validity of the reward code against a database of valid reward codes for the network of consumer product/service sponsors; and
crediting an appropriate one of the member user's accounts with a value once the reward code is verified; and
using the number of active server pages to access a number of partnered e-commerce retailers includes, wherein using the number of active server pages to access the number of partnered e-commerce retailers includes:
providing access to the number of partnered e-commerce retailers through a number of pass through servers;
using the number of active server pages to select an on-line transaction with one or more of the number of partnered e-commerce retailers; and
debiting a purchase value from an appropriate member user's account in order to provide payment for the selected on-line transaction.

51. The method of claim 50, wherein debiting a purchase value from the member user's account in order to provide payment for the selected on-line transaction includes using the number of active server pages to access a member user's commercial credit card account in order to provide an additional value to the member user's account.

52. The method of claim 50, wherein debiting the purchase value from the appropriate member user's account in order to provide payment for the selected online transaction includes collecting data associated with the on-line purchase.

53. The method of claim 52, wherein collecting data associated with the on-line purchase includes storing the collected data in the server database such that the collected data can be analyzed and shared between the network of consumer product/services and the number of partnered e-commerce retailers.

54. The method of claim 50, wherein crediting an appropriate one of the member user's accounts with a value includes crediting the member user's account with a number of additional value amounts for a number of reward codes received in connection with a number of different consumer product/services provided by the network of consumer product/service sponsors.

55. The method of claim 50, wherein receiving a reward code includes interpreting the reward code from a scanned bar code.

56. The method of claim 50, wherein the method further includes establishing a new member user account, and establishing a new member user account includes collecting a set of member user specific data.

57. The method of claim 56, wherein collecting a set of user specific data includes collecting a set of user specific data selected from the group consisting of a user name, a user identification, a user email account number, a user commercial credit card number, and a user password.

58. A system, comprising:
a server coupled to the Internet;
a website stored on the server; and
software means operative on the website and the server, wherein the software means receives one or more reward codes for verification against a network of consumer product/service sponsors and credits a proprietary value for valid reward codes to an appropriate member user's account such that a member user can apply the proprietary value to on-line transactions with a number of partnered e-commerce retailers.

59. The system of claim 58, wherein the software means is further operable for associating a reward activity process with a particular member user account and collecting data associated with an on-line transaction by the member user such that the collected data can be analyzed and shared between the network of consumer product/service sponsors and the number of partnered e-commerce retailers.
